(19) United States
(12) Patent Application Publication
(10) Pub. No.: US 2010/0115402 A1
(43) Pub. Date: May 6, 2010

(54) SYSTEM FOR DATA ENTRY USING MULTI-FUNCTION KEYS

(76) Inventors: Peter Johannes Knaven, North Vancouver (CA); Ivan Yourievitch Zubov, Burnaby (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/531,296

(22) PCT Filed: Mar. 13, 2008
(86) PCT No.: PCT/CA08/00494

§ 371 Date: Jan. 4, 2010

(30) Foreign Application Priority Data
Mar. 14, 2007 (CA) 2,581,824

(51) Int. Cl. G06F 17/27; G06F 3/048

(52) U.S. Cl. 715/261

(57) ABSTRACT

In a method, apparatus, and system of data entry, input is monitored from a plurality of input keys, including a plurality of multi-function keys. A prefix associated with at least one entry in a dictionary is generated in response to input received from at least one of the plurality of input keys. A set of predicted following characters is generated each having a representation in the dictionary immediately subsequent to the position of the prefix in one or more dictionary entries. Each predicted following character is associated with a character in a dictionary entry and with a preference value associated with that character. A dynamically ordered sequence of available following characters is generated in respect of an actuated one of the plurality of multi-function keys, comprising one or more of the predicted following characters. When the dynamically ordered sequence of available following characters comprises a plurality of predicted following characters, the predicted following characters are arranged in an order based on associated preference values. A following character hypothesis is then generated comprising a character in the dynamically ordered sequence of available following characters.

### FIELD OF THE INVENTION

This invention relates generally to data entry, and more particularly to data entry using dynamically ordered sequences of characters associated with a plurality of multi-function keys.

### BACKGROUND

Various forms of computerized input devices have many physical keys in which a plurality of characters are associated with each physical key. Examples of such devices include cellular phones and digital touch tone phones. Where a plurality of characters are mapped onto a physical key, it can be difficult and time-consuming to produce a meaningful character sequence, such as one or more lines or paragraphs of text. The main reason is that when the user is using physical keys onto which multiple characters have been mapped, the user must somehow indicate which character out of the specified set of mapped characters is actually the desired character to be selected from the applicable physical key. The order of these characters is usually fixed and displayed on the physical keys.

In one known method, often called “fixed-order multi-tap,” the first press of a key selects a first character in the plurality of characters mapped to that key. A subsequent press of the same key within a period of time from the previous press of the same key, without any intervening key presses, may be called a “correction cycle.” Each correction cycle replaces the previously selected character with a following character mapped for that key. Typically, the character selection sequence is looped, so that when the last character of the set has been chosen, another press of the same key will select the first mapped character again. The user confirms the selected character by waiting longer than a fixed period of time, or by pressing another key of the keyboard. The main criticism of the “fixed-order multi-tap” method is its low speed and inefficiency because it requires multiple key presses of the same key, sometimes for every letter in the desired word.

To counter this disadvantage of fixed-order multi-tap, a number of input systems have been developed to reduce the amount of keystrokes necessary to input information. Examples of such commercial implementations include T9™, LetterWise™, iTAP™, and EZ-Keys™.

For example, the T9™ system developed by Tegic Systems employs a method of dictionary-based disambiguation. Generally, in the T9™ system, every key press of a physical key will result in one input character, potentially reducing the number of key entries required. As the number of typed characters grows, the system tries to guess at the most likely combinations of the possible characters associated with all the pressed keys, and will automatically revise the input stream with each new key selection such that the most likely word will be active in the input stream. Because the user ideally presses every key only once, the input speed increases. However, there are several disadvantages to such an approach. For example, the user has limited control over which characters actually appear in the input stream. Also, the displayed character string is generally constantly changing with each new key press while the system is adjusting for the current most likely word. The user often has little to no expectation of what string is going to be displayed after each keystroke/key press. In addition, certain key sequences can be mapped onto a multitude of words, and if the desired word is not the most probable one according to the program's dictionary, its retrieval presents additional difficulties. This system is also very ineffective at handling novel words (words that are not stored in the program's dictionary), as any changes to the input can be made only when the user is finished typing the word.

### SUMMARY OF THE INVENTION

In accordance with one aspect of the invention there is provided a method of data entry. The method involves monitoring input from a plurality of input keys, wherein the plurality of input keys include a plurality of multi-function keys. The method further involves generating a prefix associated with at least one entry in a dictionary in response to input received from at least one of the plurality of input keys. The dictionary may include a plurality of entries each including a plurality of characters arranged in an ordered sequence and representing a word, phrase, or character sequence. The dictionary may further include a plurality of preference values each representing a current estimated user preference to select at least one of the plurality of characters of at least one of the entries to be appended to a tail end of the prefix. The method of data entry further involves generating a set of predicted following characters, each predicted following character having a representation in the dictionary immediately subsequent to the prefix in the at least one of the plurality of entries, each predicted following character associated with one of the plurality of characters of at least one of the plurality of entries, and associated with one of the preference values. The method further involves generating a dynamically ordered sequence of available following characters in respect of an actuated one of the plurality of multi-function keys, including at least one of the predicted following characters, wherein when the dynamically ordered sequence of available following characters includes a plurality of predicted following characters, the plurality of predicted following characters are arranged in an order based on the preference values associated with the plurality of predicted following characters. The method further involves generating a following character hypothesis including a character in the dynamically ordered sequence of available following characters.

Generating a prefix may further involve modifying a reference to a node in the dictionary, the node representing one of the plurality of characters of at least one of the plurality of entries in the dictionary.

Modifying a reference to a node in the dictionary may further involve modifying a dictionary search path data structure.

Generating a prefix may further involve generating a plurality of prefixes, each corresponding to at least one entry in the dictionary, and wherein each of the predicted following characters is associated with one of the plurality of prefixes.

The method may further involve multiplying the preference values associated with the predicted following characters by a respective prefix preference value weighting coefficient.

The method may further involve multiplying one of the preference values associated with the predicted following characters by a whole number equal to a number of words and partial words in the prefix.

Generating a dynamically ordered sequence of available following characters may further involve associating at least one of the predicted following characters with the actuated one of the multi-function keys.

The method may further involve generating an ordered sequence of available following characters.

Generating an ordered sequence of available following characters may further involve ordering the set of predicted following characters according to the preference values associated with the predicted following characters. The method may further involve removing all occurrences of a unique character in the set of predicted following characters except an occurrence of the unique character having a highest associated preference value among all occurrences of the unique character in the set of predicted following characters.

Generating an ordered sequence of available following characters may further involve for each unique character in the set of predicted following characters, combining all occurrences of the unique character in the set of predicted following characters into a single occurrence of the unique character having an associated preference value equal to a sum of all of the preference values associated with all occurrences of the unique character in the set of predicted following characters. The method may further involve ordering the set of predicted following characters according to the associated preference values.

When the dynamically ordered sequence of available following characters may involve the plurality of predicted following characters, the plurality of predicted following characters may be arranged in an order based on the ordered sequence of available following characters.

Generating a dynamically ordered sequence of available following characters associated with an actuated one of the plurality of multi-function keys may further involve generating a dynamically ordered sequence of available following characters involving at least one character from a preliminary ordered sequence of available following characters associated with the actuated one of the plurality of multi-function keys.

Generating a following character hypothesis may further involve generating a first following character hypothesis in response to a first press of the actuated one of the plurality of multi-function keys. The first press of the actuated one of the plurality of multi-function keys may be associated with at least one of: occurrence for a minimum period of time greater than a period of time from a most recent previous press of the actuated one of the plurality of multi-function keys; and a user selection of one of the plurality of input keys other than the actuated one of the plurality of multi-function keys after the most recent previous press of the actuated one of the plurality of multi-function keys and before the first press of the actuated one of the plurality of multi-function keys. The first following character hypothesis may be a first character in the dynamically ordered sequence of available following characters in respect of the actuated one of the plurality of multi-function keys.

Generating a following character hypothesis may further involve generating a revised following character hypothesis in response to a subsequent press of the actuated one of the plurality of multi-function keys. The first press of the actuated one of the plurality of multi-function keys may not be more than the first period of time from the most recent previous press of the actuated one of the plurality of multi-function keys, and wherein one of the plurality of input keys other than the actuated one of the plurality of multi-function keys was not pressed after the most recent previous press of the actuated one of the plurality of multi-function keys and before the first press of the actuated one of the plurality of multi-function keys. The revised following character hypothesis may be a character in the dynamically ordered sequence of available following characters in respect of the actuated one of the plurality of multi-function keys that is cyclically subsequent to a most recent following character hypothesis.

Generating a following character hypothesis may involve generating a first following character hypothesis in response to a first press of the actuated one of the plurality of multi-function keys. A most recent previous press of one of the plurality of input keys before the first press of the actuated one of the plurality of multi-function keys may not be a press of the actuated one of the plurality of multi-function keys. The first following character hypothesis may be a first character in the dynamically ordered sequence of available following characters in respect of the actuated one of the plurality of multi-function keys.

Generating a following character hypothesis may further involve generating a revised following character hypothesis in response to a continuous press of the actuated one of the plurality of multi-function keys throughout a second period of time from a beginning of the continuous press of the actuated one of the plurality of multi-function keys or throughout a third period of time from a most recent generation of a revised following character hypothesis. The revised following character hypothesis may be a character in the dynamically ordered sequence of available following characters in respect of the actuated one of the plurality of multi-function keys that is cyclically subsequent to a most recent following character hypothesis.

Generating a following character hypothesis may further involve generating a revised following character hypothesis in response to a continuous press of the actuated one of the plurality of multi-function keys throughout a second period of time from a beginning of the continuous press of the actuated one of the plurality of multi-function keys. The revised following character hypothesis may be a character in the dynamically ordered sequence of available following characters in respect of the actuated one of the plurality of multi-function keys that is cyclically subsequent to a most recent following character hypothesis.

Generating a dynamically ordered sequence of available following characters in respect of the actuated one of the plurality of multi-function keys may be in response to actuation of the actuated one of the plurality of multi-function keys.

Generating a dynamically ordered sequence of available following characters in respect of the actuated one of the plurality of multi-function keys may be in response to actuation of one of the plurality of input keys.

Generating a dynamically ordered sequence of available following characters in respect of the actuated one of the plurality of multi-function keys may be in response to a passage of the minimum period of time from a most recent press of one of the plurality of multi-function keys.

The method may further involve updating the dictionary.

The method may further involve causing a multi-function key character selection dialog to appear on a display.

Generating a following character hypothesis may involve responding to user selection of a character represented in the multi-function key character selection dialog.

Causing a searchable list may involve at least one predicted completion candidate to appear on a display.

The method may further involve causing a most likely predicted completion candidate on the searchable list to be indicated on the display.

Causing a most likely predicted completion candidate on the searchable list to be indicated on the display may involve causing an anchor icon to appear on the display in association with the most likely predicted completion candidate.

The method may further involve causing the searchable list to be resized in response to actuation of at least one of the plurality of input keys.

Generating a following character hypothesis may involve responding to user selection of a predicted completion candidate in the searchable list.

The method may further involve causing a representation of the dynamically ordered sequence of available following characters to appear on a display.

The method and its variations may be applied to many types of computing devices and may be stored as computer-readable instructions in one or more types of computer-readable media.

In accordance with another aspect of the invention, there is provided a computer readable medium having stored instructions for directing a processor to carry out the method and its variations.

In accordance with another aspect of the invention, there is provided an apparatus for data entry. The apparatus includes a processor, and a computer readable medium having stored instructions for directing the processor to carry out the method and its variations.

In accordance with another aspect of the invention, there is provided a data entry system. The system includes provisions for monitoring input from a plurality of input keys, wherein the plurality of input keys include a plurality of multi-function keys. The system further includes provisions for generating a prefix associated with at least one entry in a dictionary in response to input received from at least one of the plurality of input keys. The dictionary may include a plurality of entries each comprising a plurality of characters arranged in an ordered sequence and representing a word, phrase, or character sequence. The dictionary may further include a plurality of preference values each representing a current estimated user preference to select at least one of the plurality of characters of at least one of the entries to be appended to a tail end of the prefix. The system further includes provisions for generating a set of predicted following characters, each predicted following character having a representation in the dictionary immediately subsequent to the prefix in the at least one of the plurality of entries, each predicted following character associated with one of the plurality of characters of at least one of the plurality of entries, and associated with one of the preference values. The system further includes provisions for generating a dynamically ordered sequence of available following characters in respect of an actuated one of the plurality of multi-function keys, comprising at least one of the predicted following characters, wherein when the dynamically ordered sequence of available following characters comprises a plurality of predicted following characters, the plurality of predicted following characters are arranged in an order based on the preference values associated with the plurality of predicted following characters. The system further includes provisions for generating a following character hypothesis comprising a character in the dynamically ordered sequence of available following characters.

The foregoing aspects and several other aspects of the invention will become more apparent from the following description of specific embodiments thereof and the accompanying drawings which illustrate, by way of example only, the principles of the invention. Each of the aspects of the invention serves as an embodiment of the invention.

### BRIEF DESCRIPTION OF THE DRAWINGS

In drawings which illustrate embodiments of the invention,

FIG. 1 is a schematic view of a computing device in accordance with a first embodiment of the invention,

FIG. 2 is a schematic view of a processor circuit in the device shown in FIG. 1,

FIG. 3 is a schematic view of a set of preliminary ordered sequences of available following characters for multi-function keys in the device shown in FIG. 1,

FIG. 4 is an example of a dictionary structure and dictionary search path data structures for a sample text entry in the device shown in FIG. 1,

FIG. 5 is an exemplary flowchart including blocks of code for directing the processor circuit shown in FIG. 2 to update dictionary search path data structures for an added character,

FIG. 6A is an exemplary flowchart including blocks of code for directing the processor circuit shown in FIG. 2 to perform the functions of the key mapping unit in the “multi-tap correction cycle” mode,

FIG. 6B is an exemplary flowchart including blocks of code for directing the processor circuit shown in FIG. 2 to perform the functions of the key mapping unit in the “hold-to-scan correction cycle” mode,

FIG. 7 is an exemplary flowchart including blocks of code for directing the processor circuit shown in FIG. 2 to generate dynamically ordered sequences of available following characters,

FIG. 8 is an exemplary flowchart including blocks of code for directing the processor circuit shown in FIG. 2 to generate an ordered sequence of predicted following characters,

FIG. 9 is a schematic view of an example of a set of dynamically ordered sequences of available following characters produced by the operation of the blocks of code shown in FIG. 7, using the sample dictionary structure and dictionary search path data structures shown in FIG. 4,

FIG. 10 is an illustration of a multi-function key character selection dialog on the device shown in FIG. 1, and

FIG. 11 is an illustration of an expanded searchable list on the device shown in FIG. 1.

### DETAILED DESCRIPTION

General

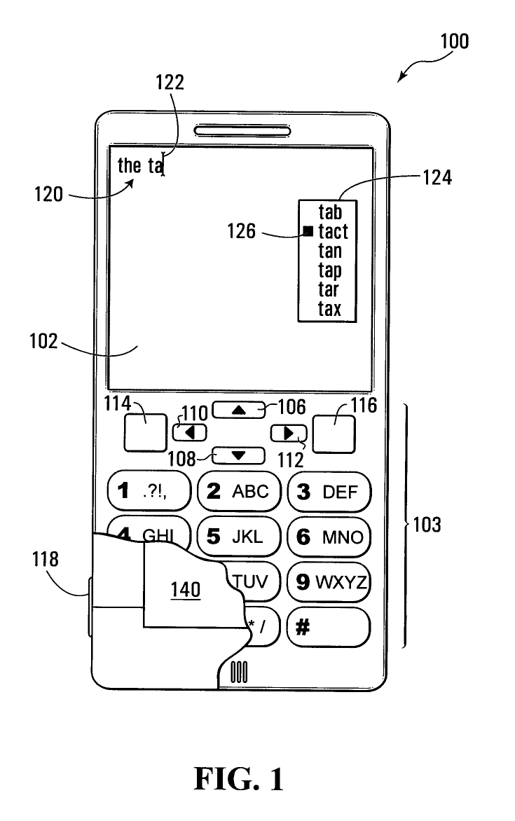

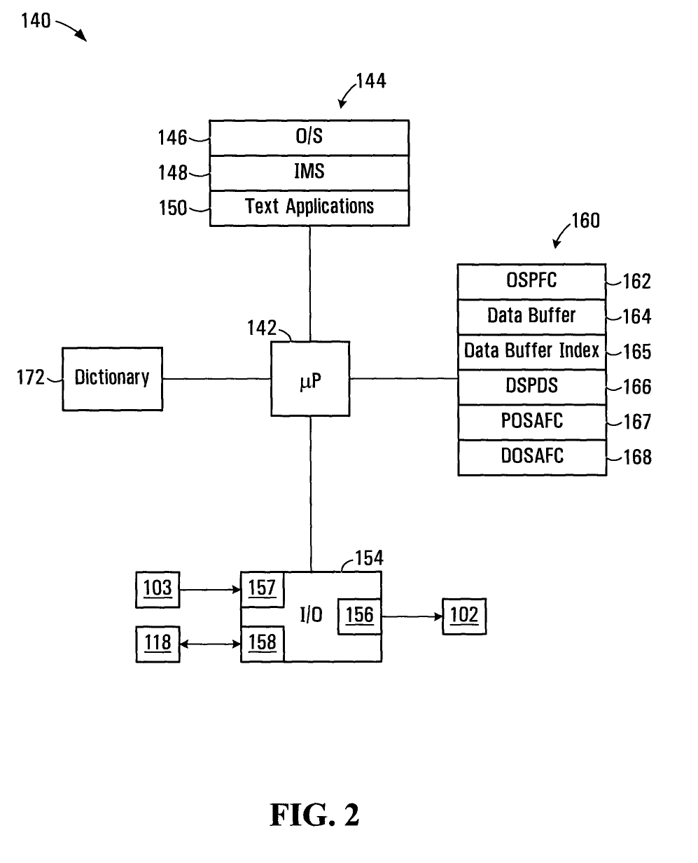

Referring to FIG. 1, a computing device according to a first embodiment of the invention is illustrated schematically and shown generally at 100. The “first embodiment” described herein, and the other embodiments described herein, are illustrative examples only, and are not limiting of the invention. The computing device 100 includes a display 102 and input keys 103. In this embodiment, the input keys 103 include a standard twelve-key telephone key arrangement, an up arrow 106, a down arrow 108, a left arrow 110, a right arrow 112, a backspace key 114, and an enter key 116. However, for the purposes of the present invention, other numbers and combinations of input keys 103 may be present. The computing device 100 also includes a processor circuit 140, shown in greater detail in FIG. 2. The computing device 100 also includes a data port 118, which may be a cable port for receiving a cable such as a USB cable, or it may be a wireless port for a Bluetooth™ or other wireless connection. In this first embodiment, the computing device 100 is a cellular telephone, but in other embodiments, it may be another type of telephone having a digital display or screen, a personal digital assistant, or another form of computing device having a set of multi-function input keys and in communication with a digital display or screen.

One or more of the input keys 103 may be designated as multi-function keys 104. A multi-function key 104 is an input key 103 that is used for data entry and is “overloaded” because it has more than one character associated with it.

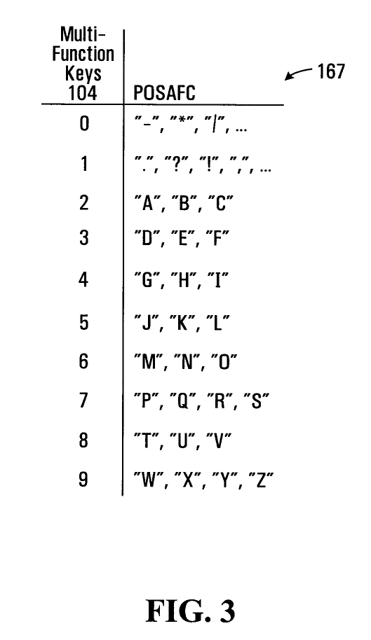

In the first embodiment, as shown in FIG. 3, the multi-function keys 104 are the ten input keys 103 from “0” to “9” inclusive on the standard twelve-key telephone key arrangement. However, in an alternative embodiment, other keys may be designated multi-function keys 104, and the user may be able to customize which of the input keys 103 are multi-function keys.

Referring back to FIG. 1, the input keys 103 in the embodiment shown are physical keys attached to the computing device 100, and are configured to form a keypad. However, the input keys 103 may alternatively be configured to form part of other keyboard-type devices, such as a physical keyboard. In yet another alternative, a virtual keyboard-type device may be used comprising virtual representations of the input keys 103, where the keys are virtually displayed on a display screen and events from a stylus, mouse, or other pointing device or input device are treated as key presses. Alternatively, in another variation, the input keys 103 may form part of a graphically delimited portion of a touch-sensitive screen that can be pressed and released. In yet a further alternative, the input keys 103 may be detached from and in wired or wireless communication with the computing device 100.

Referring to FIG. 2, the processor circuit of the computing device 100 is illustrated schematically and shown generally at 140. The processor circuit 140 includes a processing unit represented by microprocessor 142, a program memory 144, an input/output port (I/O) 154, a memory store illustrated as random access memory (RAM) 160, and a dictionary 172, all of which are in communication with the microprocessor 142. The dictionary 172 may be stored in a random access memory, a read-only memory, a flash memory, a hard disk drive, or a combination thereof. It will be appreciated that there may be many variations in the configuration of the processor circuit 140, and that the description herein is an example only.

In the first embodiment, program codes for directing the microprocessor 142 to carry out various functions are stored in the program memory 144 as stored instructions. The program memory 144 is a computer-readable medium, which may be, for illustrative purposes, a random access memory, read-only memory, flash memory, a hard disk drive, or a combination of two or more of the foregoing. In the first embodiment, the program memory 144 includes a first program codes memory store 146 for storing program codes for an operating system (also referred to herein as “O/S”), a second program codes memory store 148 for storing program codes for directing the microprocessor 142 to carry out the functions of an input management system (also referred to herein as “IMS”), and a third program codes memory store 150 for storing program codes for directing the microprocessor 142 to carry out the functions of one or more text applications.

In the first embodiment, the operating system in the first program codes memory store 146 is Microsoft™ Windows™ Mobile™ 5.0 for SmartPhones, although any suitable operating system or the like may be used. The text applications represented by the program codes in the third program codes memory store 150 may include a short message service (SMS) application, another text application such as a text editing application, an email application, a chat application, or any combination of suitable text applications. In other variations, the program codes implementing the functions of the operating system, the input management system (discussed below), or the text applications may be combined in any combination thereof, or divided into separate program codes memory stores.

The I/O 154 includes a video display circuit 156 operable to control the image displayed on the display 102. The I/O 154 also includes a first interface 157 in communication with the input keys 103, and a second interface 158 in communication with the data port 118. The data port 118 may facilitate loading program codes into the program memory 144 from a computer-readable signal or other computer-readable medium.

In the first embodiment, the RAM 160 includes a first RAM store 162 for storing an ordered sequence of predicted following characters (also referred to herein as an “OSPFC”), a second RAM store 164 for storing a data buffer (also referred to herein as the data buffer 164), a third RAM store 165 for storing an index to the data buffer, a fourth RAM store 166 for storing one or more dictionary search path data structures (also referred to herein as “DSPDS”), a fifth RAM store 167 for storing preliminary ordered sequences of available following characters (also referred to herein as “POSAFC”) associated with respective multi-function keys 104, and a sixth RAM store 168 for storing dynamically ordered sequences of available following characters (also referred to herein as “DOSAFC”) associated with respective multi-function keys 104.

The following table summarizes functions of the data structures in the RAM 160, as explained in detail below.

| Data Structure | Location | Summary of Function |
|---|---|---|
| Data buffer | Second | Stores characters that the user has entered |
| | RAM | using the input keys 103 according to the |
| | store 164 | methods explained in detail below. |
| Index to the data | Third | Stores a representation of a current data entry |
| buffer | RAM | position in the data buffer 164; it may be a |
| | store 165 | pointer to a memory address within the data |
| | | buffer 164, for example. |
| Dictionary search path | Fourth | Store representations of relevant data prefixes |
| data structures | RAM | in association with the dictionary 172. |
| | store 166 | |
| Ordered sequence of | First | Stores a sequence of characters that may |
| predicted following | RAM | follow the prefix or prefixes represented by |
| characters | store 162 | the dictionary search path data structures in |
| | | the fourth RAM store 166, ordered according |
| | | to preference values in the dictionary 172. |
| Preliminary ordered | Fifth | Stores initial sequences of characters |
| sequences of available | RAM | associated with multi-function keys 104. An |
| following characters | store 167 | example of a set of preliminary ordered |
| | | sequences of available following characters is |
| | | shown in FIG. 3. |
| Dynamically ordered | Sixth | Stores sequences of characters associated with |
| sequences of available | RAM | multi-function keys 104 that are dynamically |
| following characters | store 168 | generated in response to the ordered sequence |
| | | of predicted following characters in the first |
| | | RAM store 162. |

The user may configure the computing device 100 to receive text input into an active text application using steps specified by the operating system in the first program codes memory store 146. The computing device 100 then monitors the input keys 103 for user actuation. Examples of methods of monitoring input keys are illustrated in International Publication No. WO 2006/074530 A1. In the first embodiment, when the user actuates one of the input keys 103, an input key signal (not shown) is received in the I/O 154. Each time the user presses or releases an input key 103, the microprocessor 142 generates an input key event data structure (not shown) that includes codes denoting which input key 103 generated the event and whether the event was generated from a press or release of the input key.

In response to input key events, the microprocessor 142 executes program codes for the input management system in the second program codes memory store 148 that, without limitation, update the data buffer 164, the data buffer index in the third RAM store 165, and the dictionary search path data structures in the fourth RAM store 166 to reflect the user's data input, as explained in detail below. Also, the active text application program codes in the third program codes memory store 150 respond to the input key events, and cause displayed text 120 and a cursor marker 122 (shown in FIG. 1) to be displayed on the display 102.

In the first embodiment, the data buffer 164 and the data buffer index in the third

RAM store 165 are accessed only by the input management system in the second program codes memory store 148 and are not accessed by an active text application in the third program codes memory store 150. However, the program codes for the input management system in the second program codes memory store 148 and the program codes for the active text application in the third program codes memory store 150 both respond to input key events, so the displayed text 120 will generally correspond to the data in the data buffer 164, and the position of the cursor marker 122 will generally correspond to the location in the data buffer 164 that is specified by the data buffer index in the third RAM store 165. In other embodiments, however, the active text application may access the data buffer 164 and the data buffer index in the third RAM store 165, or the input management system in the second program codes memory store 148 may directly control the display 102, the displayed text 120, and/or the cursor marker 122.

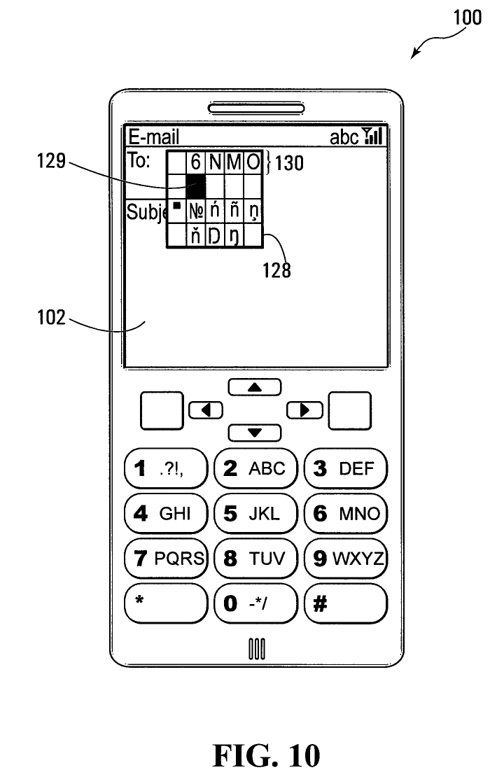

As explained in detail below, a searchable list 124 of predicted completion candidates may appear on the display 102, as shown in FIG. 1. Also, explained in detail below, a multi-function key character selection dialog 128 may appear on the display 102, as shown in FIG. 10. In the first embodiment, if the searchable list 124 is minimized or is displaying no predicted completion candidates, and if the multi-function key character selection dialog 128 is not on the display 102, then the user may relocate the cursor marker 122 using the arrow keys 106, 108, 110, and 112. However, as explained in detail below, the arrow keys 106, 108, 110, and 112 take on different functions when either the searchable list 124 shown in FIG. 1 appears on the display 102 and contains at least one predicted completion candidate, or the multi-function key character selection dialog 128 shown in FIG. 10 is on the display 102.

The user may also delete a character preceding the data buffer index in the third RAM store 165 using the backspace key 114. The input management system program codes in the second program codes memory store 148 direct the microprocessor 142 to, without limitation, adjust the data buffer 164, the data buffer index in the third RAM store 165, and the dictionary search path data structures in the fourth RAM store 166 in response to deletion or insertion of a character.

As mentioned above, in other embodiments, other numbers and combinations of input keys 103 may be present, and the user may be able to customize the functions of the input keys 103.

The user enters data by actuating a multi-function key 104 that is associated with a desired character for insertion. A “character” (as the word is used herein) is drawn from an alphabet of available characters, and may include any character from any language, or any symbol or other element for data entry. In the first embodiment, by way of example only, the alphabet of available characters includes the following character sets:

(1) English-language alphabetical characters (“A” to “Z”);

(2) number characters (“0” to “9”);

(3) mathematical characters (such as “−”, “*”, and “/”);

(4) punctuation characters (such as “.”, “?”, “!”, and “,”); and

(5) derived characters, which are characters with diacritical marks or other characters that are not included in the character sets (1) to (4) above, but are each associated with one similar character (called a “base character”) in the character sets (1) to (4) above according to a character correspondence table (for example, “á”, “\check{a}”, “æ”, “@”, and “ã” may be derived characters associated to the base character “a”).

In the first embodiment, as explained in detail below, the inclusion of derived characters in the alphabet of available characters advantageously permits the user to enter characters, and cause the dictionary 172 to include entries having characters, that are not normally readily available on a limited number of input keys 103. Moreover, as explained below, the association of derived characters to base characters advantageously permits derived characters to be included in the dynamically ordered sequence of available following characters in the sixth RAM store 168, so that the user may more easily enter words, phrases, and/or character sequences from the dictionary 172 that include one or more derived characters. However, variations of the first embodiment may or may not include derived characters.

The first embodiment is case-insentitive; that is, the data structures and methods described herein operate on characters regardless of whether the characters may be upper-case (such as “A”) or lower-case (such as “a”). Therefore, references herein to an upper-case character (such as “A”) and to a lower-case (such as “a”) must be understood as references to the character, regardless of its case. However, in other embodiments, case may be significant, and the data structures and methods described herein may be applied to case-sensitive representations of characters.

In another embodiment, the alphabet may be configured to be any set of characters, such as the characters in any known language, or any standard set of characters known in the art, such as the American Standard Code for Information Interchange (ASCII), the Extended Binary Coded Decimal Interexchange Code (EBCDIC), a binary coded decimal (BCD), or Unicode.

Referring to FIG. 3, the preliminary ordered sequences of available following characters associated with the multi-function keys 104 for the first embodiment is shown generally at 167. In this embodiment, the multi-function key 104 labeled “0” is associated with a preliminary ordered sequence of available following characters consisting of the mathematical characters in character set (3) described above, the multi-function key 104 labeled “1” is associated with a preliminary ordered sequence of available following characters consisting of the punctuation characters in character set (4) described above, the multi-function key 104 labeled “2” is associated with the preliminary ordered sequence of available following characters (“A”, “B”, “C”), the multi-function key 104 labeled “3” is associated with the preliminary ordered sequence of available following characters (“D”, “E”, “F”), and the remaining multi-function keys 104 are associated with the preliminary ordered sequences of available following characters as shown in FIG. 3. In the first embodiment, the user enters and returns from a separate number character entry mode (by holding down the “*” key for a pre-determined period of time) in order to enter the number characters in character set (4) described above. However, it will be appreciated that alternatively, the number characters in character set (4) described above may appear in the preliminary ordered sequences of available following characters.

In the first embodiment, the preliminary ordered sequences of available following characters in the fifth RAM store 167 are a variation from the hardware-specified mapping of characters to keys. However, in other embodiments, the preliminary ordered sequences of available following characters in the fifth RAM store 167 may be the hardware-specified mapping of characters to keys.

In an alternative embodiment, the user would not be confined to the exemplary set of preliminary ordered sequences of available following characters shown in FIG. 3. Rather, an alternative embodiment could have a different set of preliminary ordered sequences of available following characters in the fifth RAM store 167, or the user could customize the preliminary ordered sequences of available following characters in the fifth RAM store 167.

In another alternative embodiment, for example, the computing device 100 could have three multi-function keys 104. In that alternative embodiment, the preliminary ordered sequences of available following characters in the fifth RAM store 167 could associate all vowels with a first multi-function key 104, all consonants with a second multi-function key 104, and all remaining characters with a third multi-function key 104. Or, as another embodiment having three multi-function keys 104, the preliminary ordered sequences of available following characters in the fifth RAM store 167 could associate all numbers with a first multi-function key 104, all letters with a second multi-function key 104, and all remaining characters with a third multi-function key 104.

Prediction Engine

In the first embodiment, the input management system in the second program codes memory store 148 includes a prediction engine configured to predict and retrieve one or more predicted following characters and/or completion candidates from the dictionary 172. The dictionary 172 can have any number of words, phrases, and/or character sequences (each of which is referred to herein as an “entry”) that can be selectively used by the input management system as one or more predicted completion candidates for a data prefix. In the first embodiment, each entry includes a plurality of characters in an ordered sequence.

Examples of dictionaries and prediction engines, which are also referred to as “predictive text entry systems,” are illustrated in International Publication No. WO 02/33527 A2 and in International Publication No. WO 00/57265.

In the first embodiment, as illustrated in International Publication No. WO 02/33527 A2, the dictionary 172 is structured as a tree, wherein the tree includes a root node, and each node of the tree, other than the root node, represents a character in one or more dictionary entries. Each node in the tree, other than the root node, includes a preference value representing an estimated weighted value associated with the likelihood of one or more entries associated with that node, and a flag indicating whether the node can represent an end of an entry. However, in other embodiments, the dictionary 172 may be structured in other ways. For example, in other embodiments, preference values may be omitted for some nodes.

As illustrated in International Publication No. WO 02/33527 A2, the dictionary 172 can adapt to include words, phrases, and/or character sequences that a user has added or used but were not previously in the dictionary, and the preference values in the dictionary 172 may be dynamically generated and/or modified based on a user's data entry history.

Also, as illustrated in International Publication No. WO 02/33527 A2, a dictionary search path data structure may store a location in the dictionary tree representing a search path structure through the dictionary 172 for a given prefix, which is also referred to as a “partial text entry.”

In the first embodiment, as explained in detail below, the dictionary search path data structures in the fourth RAM store 166 store locations in the dictionary tree 172 representing relevant prefixes. In the first embodiment, a pre-determined number (which may be one or more) of dictionary search path data structures are stored in the fourth RAM store 166, and each dictionary search path data structure may be configured to be “active” or “inactive”. An “active” dictionary search path data structure represents a search path structure through the dictionary 172 corresponding to a prefix, whereas an “inactive” dictionary search path data structure does not represent a search path structure through the dictionary 172, and does not represent a prefix. The operation and advantages of the dictionary search path data structures in the fourth RAM store 166 are explained in detail below.

In other embodiments, the relevant prefixes may be stored or represented in other data structures or in other ways, and the representations of the relevant prefixes may be maintained in other ways. For example, the relevant prefixes may be stored as any reference to a node in the dictionary 172. Thus, reference below to dictionary search path data structures in the fourth RAM store 166 may be understood to refer to different data structures in other embodiments, and reference below to operations such as configuring a dictionary search path data structure to be “active” or “inactive” may be understood to refer to appropriate operations on the data structures in other embodiments.

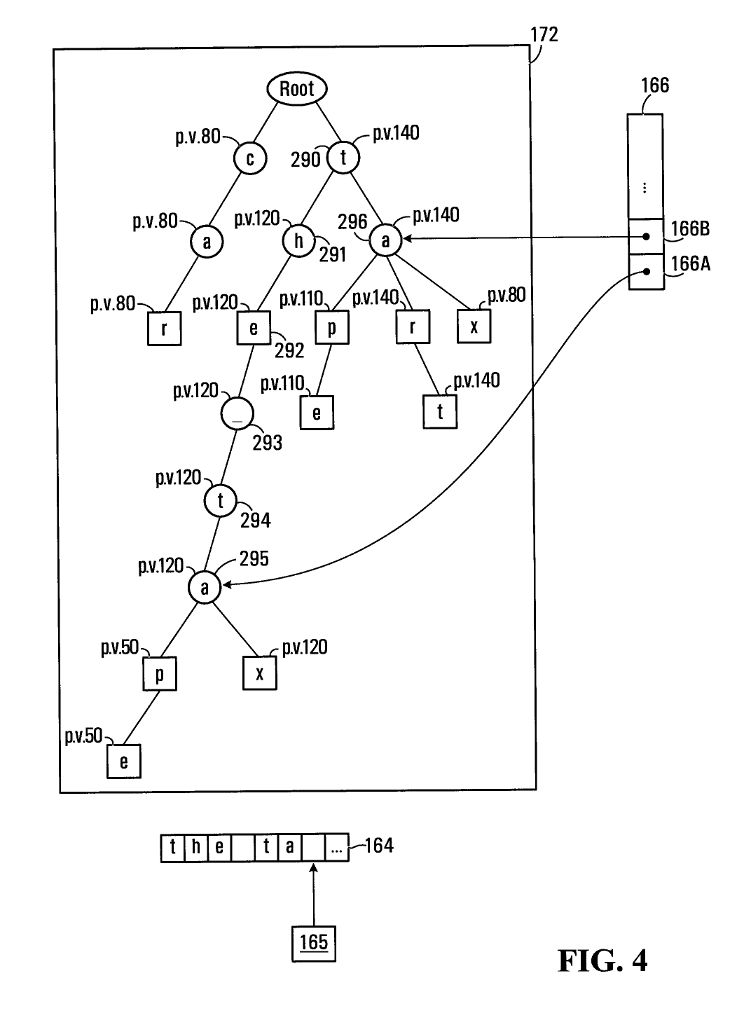

Referring to FIG. 4, an example of a sample dictionary 172 is illustrated. For illustration purposes only, the dictionary 172 is shown in FIG. 4 having seven words (“car”, “tap”, “tape”, “tar”, “tart”, “tax”, and “the”) and three phrases (“the tap”, “the tape”, and “the tax”). As mentioned earlier, the dictionary 172 can have any number of words, phrases, and/or character sequences. In FIG. 4, a node that can represent an end of an entry is drawn as a square, whereas a node that cannot represent an end of an entry is drawn as a circle.

Aspects of the operation of the dictionary search path data structures in the fourth RAM store 166 are illustrated with reference to FIG. 4. In the example of FIG. 4, the user has already entered the string “the ta” which is stored in the data buffer 164, and the data buffer index in the third RAM store 165 points to the end of the string “the ta”. In the example of FIG. 4, there are two possible prefixes associated with the string “the ta”. A first dictionary search path data structure 166A points to a node 295 corresponding to the character “a” and the prefix “the ta” while a second dictionary search path data structure 166B points to a node 296 corresponding to the character “a” and the prefix “ta”. It will be explained in detail by example below how the dictionary search path data structures in the fourth RAM store 166 may be maintained.

In the first embodiment, the user may enter a “words only” mode. In the “words only” mode, there is only a single dictionary search path data structure in the fourth RAM store 166, and the prefix represented by the single dictionary search path data structure in the fourth RAM store 166 will be a word (and not a phrase). However, for the purposes of illustration, the user is not in the “words only” mode in the example of FIG. 4, so the prefixes represented by the dictionary search path data structures in the fourth RAM store 166 may include phrases. A separate “words only” mode is not essential.

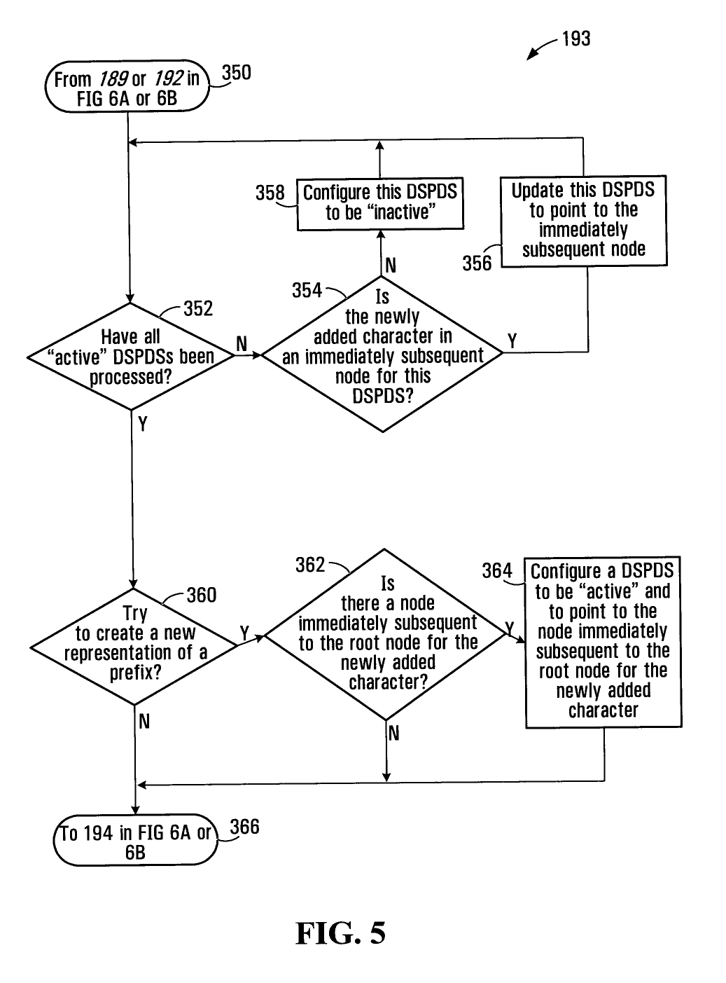

When the user adds a character to the data buffer 164, the microprocessor 142 updates the dictionary search path data structures in the fourth RAM store 166 to reflect the newly added character. The process for updating the dictionary search path data structures in the fourth RAM store 166 to reflect the newly added character is illustrated below by example with reference to FIG. 4, and is explained in detail below by example with reference to FIG. 5.

Referring to the example of FIG. 4, when the user added the first character “t” in the data buffer 164, the microprocessor 142 caused the first dictionary search path data structure 166A to be “active” and to point to the node “t” 290 that is directly below the root node. As the user added the subsequent characters “h”, “e”, and “_” (representing a space), the microprocessor 142 updated the first dictionary search path data structure 166A to point to the subsequent nodes “h” 291, “e” 292, and “_” 293.

When the user added the second “t” character (such that the data buffer 164 contained the string “the t”), the microprocessor 142 updated the first dictionary search path data structure 166A to point to the subsequent node “t” 294. However, because the character “t” can also represent a first character of a prefix, the microprocessor 142 also caused the second dictionary search path data structure 166B to be “active” and to point to the node “t” 290 that is directly below the root node.

In the first embodiment, the microprocessor 142 is configured to cause a dictionary search path data structure in the fourth RAM store 166 to represent a new prefix if the previously added character was a space character, or if there are no characters in the data buffer 164. However, in other embodiments, different criteria are possible for beginning a prefix. For example, a prefix may begin if the previously added character was a carriage return, a space character, any mathematical character in character set (3) described above, any punctuation character in character set (4) described above, or any combination or subset of these characters.

If, in the example of FIG. 4, after having added the characters “t”, “h”, “e”, “_”, and “t”, the user had added a character “h”, then the microprocessor 142 would have updated the second dictionary search path data structure 166B to point to the subsequent node “h” 291, but configured the first dictionary search path data structure 166A to be “inactive” because no node “h” subsequent to node 294 is available in this example dictionary 172.

However in the example of FIG. 4, after having added the characters “t”, “h”, “e”, “_”, and “t”, the user added a character “a”. Therefore, the microprocessor 142 updated the dictionary search path data structures 166A and 166B to point to the respective subsequent nodes “a” 295 and 296, as shown in FIG. 4.

From the example of FIG. 4, the advantage of configuring a dictionary search path data structure in the fourth RAM store 166 to be “inactive”, rather than simply deleting it, may be illustrated. As shown above, if after having added the characters “t”, “h”, “e”, “_”, and “t”, the user had added a character “h”, then the microprocessor 142 would have configured the first dictionary search path data structure 166A to be “inactive” because no node “h” subsequent to node 294 is available in this example dictionary 172. If the user had then pressed the backspace key 114, then the microprocessor 142 would have configured the first dictionary search path data structure 166A to be “active” again because the prefix “the t” would again be relevant. In this example, if the microprocessor 142 had deleted the first dictionary search path data structure 166A, rather than configuring it to be “inactive”, then it would not be possible to restore the first dictionary search path data structure 166A when the user pressed the backspace key 114. Thus, in the first embodiment, when the user presses the backspace key 114, the microprocessor 142 will determine whether any “inactive” dictionary search path data structures in the fourth RAM store 166 represent prefixes according to the relevant criteria described herein, and will configure the dictionary search path data structures in the fourth RAM store 166 that represent prefixes according to the relevant criteria described herein to be “active”.

Referring to FIG. 5, an exemplary flowchart of blocks of code for directing the microprocessor 142 to update the dictionary search path data structures in the fourth RAM store 166 to reflect a newly added character is shown generally at 193. The blocks 193 in FIG. 5 generally represent codes that may be stored in the program memory 144, for directing the microprocessor 142 to perform various functions related to updating the dictionary search path data structures in the fourth RAM store 166 to reflect a newly added character. The actual code to implement each block may be written in any suitable program language, such as Java, C, and/or C++, for example.

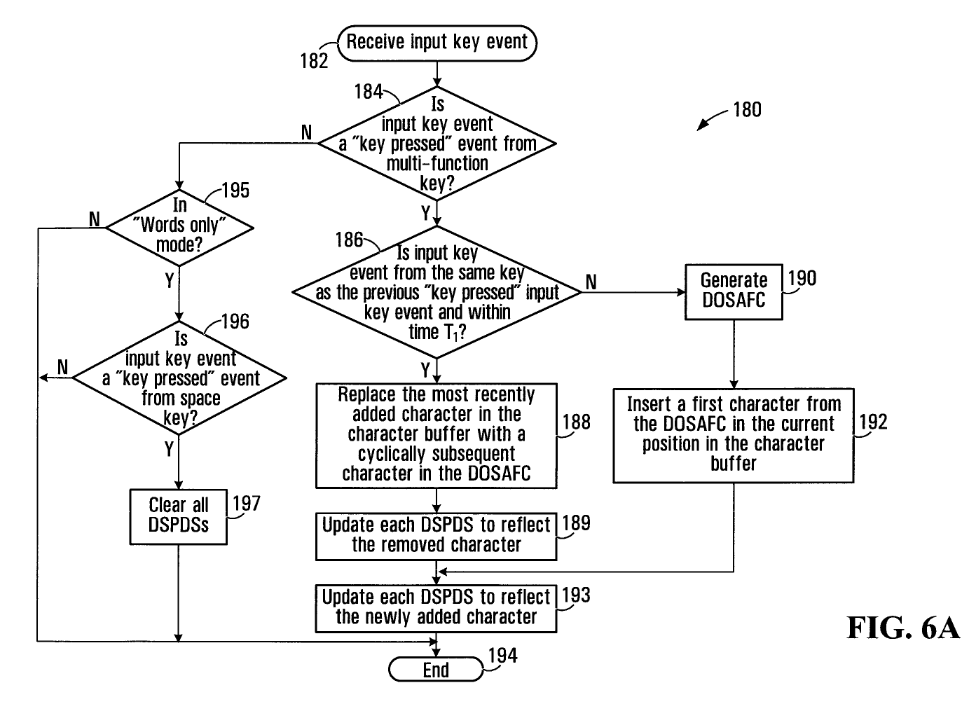

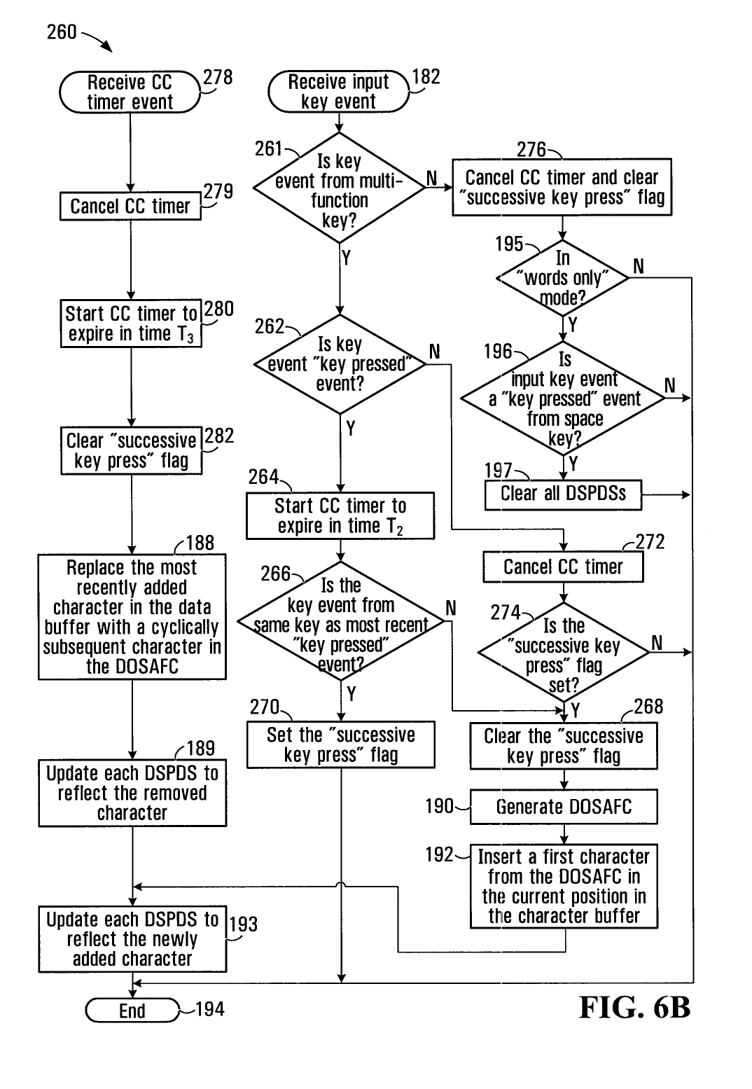

As explained in detail below, the process 193 is part of the process 180 shown in FIG. 6A, and it is part of the process 260 shown in FIG. 6B. Therefore, the process 193 begins at 350, continuing after either block 189 or block 192 in either the process 180 shown FIG. 6A or the process 260 shown in FIG. 6B. If the process 193 began after either block 189 or block 192 in the process 180 shown in FIG. 6A, then when the process 193 terminates at 366, it returns to 194 in the process 180 shown in FIG. 6A. However, if the process 193 began after either block 189 or block 192 in the process 260 shown in FIG. 6B, then when the process 193 terminates at 366, it returns to 194 in the process 260 shown in FIG. 6B.

The process 193 iterates through each “active” dictionary search path data structure in the fourth RAM store 166. Therefore, the process 193 continues at block 352, which directs the microprocessor 142 to determine whether all of the “active” dictionary search path data structures in the fourth RAM store 166 have been considered in the process 193.

If at block 352 not all of the “active” dictionary search path data structures in the fourth RAM store 166 have been considered in the process 193, then the process 193 continues at block 354.

Before proceeding at block 354, the microprocessor 142 identifies an “active” dictionary search path data structure in the fourth RAM store 166 that has yet to be considered in the process 193, which is referred to in the description below of the blocks 354, 356, and 358 as “the currently processed dictionary search path data structure in the fourth RAM store 166.”

The program codes in block 354 direct the microprocessor 142 to determine whether there is a node immediately subsequent to the node pointed to by the currently processed dictionary search path data structure in the fourth RAM store 166 that represents the newly added character.

If at block 354 there is a node immediately subsequent to the node pointed to by the currently processed dictionary search path data structure in the fourth RAM store 166 that represents the newly added character, then the process 193 continues at block 356, which directs the microprocessor 142 to update the currently processed dictionary search path data structure in the fourth RAM store 166 to point to the subsequent node that represents the newly added character. The process 193 then returns to block 352 to determine whether all of the “active” dictionary search path data structures in the fourth RAM store 166 have been considered in the process 193.

But if at block 354 there is not a node immediately subsequent to the node pointed to by the currently processed dictionary search path data structure in the fourth RAM store 166 that represents the newly added character, then the process 193 continues at block 358, which directs the microprocessor 142 to configure the currently processed dictionary search path data structure in the fourth RAM store 166 as “inactive”. The process 193 then returns to block 352 to determine whether all of the “active” dictionary search path data structures in the fourth RAM store 166 have been considered in the process 193.

If at block 352 all of the “active” dictionary search path data structures in the fourth RAM store 166 have been considered in the process 193, then the process 193 continues at block 360, which directs the microprocessor 142 to determine whether to try to create a new representation of a prefix. At block 360 in the first embodiment, as explained above, the microprocessor 142 will determine that it should try to create a new representation of a prefix if either the previously added character was a space character, or there are no characters in the data buffer 164. However, as mentioned above, in other embodiments, different criteria are possible for beginning a representation of a prefix.

If at block 360 the microprocessor 142 has determined that it will not try to create a new representation of a prefix, the process 193 then completes at 366, which returns to 194 in either FIG. 6A or 6B, as explained above.

However, if at block 360 the microprocessor 142 has determined that it will try to create a new representation of a prefix, then the process 193 continues at block 362, which directs the microprocessor 142 to determine whether there is a node immediately subsequent to the root node that represents the newly added character.

If at block 362 there is not a node immediately subsequent to the root node that represents the newly added character, then there is no possible new prefix to begin, so the process 193 completes at 366, which returns to 194 in either FIG. 6A or 6B, as explained above.

But if at block 362, there is a node immediately subsequent to the root node that represents the newly added character, then there is a new prefix to begin, and the process 193 continues at block 364, which directs the microprocessor 142 to configure a dictionary search path data structure in the fourth RAM store 166 to be “active” and to point to the node immediately subsequent to the root node that represents the newly added character.

As explained above, in the first embodiment, a pre-determined number (one or more) of dictionary search path data structures are stored in the fourth RAM store 166. Each time the program codes at block 364 are executed, the microprocessor 142 identifies a cyclically subsequent dictionary search path data structure in the fourth RAM store 166 to be configured to be “active” and to point to the node immediately subsequent to the root node that represents the newly added character. Thus, in the first embodiment, once each dictionary search path data structure in the fourth RAM store 166 has stored a representation of a prefix, the program codes at block 364 direct the microprocessor 142 to store a new representation of a prefix in place of the oldest representation of a prefix in the dictionary search path data structure in the fourth RAM store 166. However, in other embodiments, other representations of prefixes are possible, and other methods of deleting or inactivating representations of prefixes may be used.

The process 193 then completes at 366, which returns to 194 in either FIG. 6A or 6B, as explained above.

Key Mapping Unit

In the first embodiment, the input management system in the second program codes memory store 148 includes a key mapping unit, which directs the microprocessor 142 to generate dynamically ordered sequences of available following characters associated with one or more of the multi-function keys 104 and to store same in the sixth RAM store 168. The characters in a dynamically ordered sequence of available following characters in the sixth RAM store 168 are in an order of decreasing likelihood according to the prediction engine. This advantageously enables the user to enter data with potentially fewer correction cycles.

The first embodiment is capable of being configured in one of three correction cycle modes: a “multi-tap correction cycle” mode, a “hold-to-scan correction cycle” mode, or a “slow-tap correction cycle” mode. These various modes in the first embodiment are discussed in detail below.

Although the three correction cycle modes (“multi-tap correction cycle” mode, “hold-to-scan correction cycle” mode, and “slow-tap correction cycle” mode) are discussed below in the context of cycling through dynamically ordered sequences of available following characters in the sixth RAM store 168, these three correction cycle modes may be optionally applied to any sequences of available following characters associated with one or more multi-function keys, including but not limited to preliminary ordered sequences of available following characters discussed herein.

Key Mapping Unit in “Multi-Tap Correction Cycle” Mode

Generally speaking, in the “multi-tap correction cycle” mode, the first press of a multi-function key 104 selects the first character from the plurality of characters mapped to that multi-function key, and a subsequent press of the same multi-function key within a period of time T₁ from the most recent press of the same multi-function key, without any intervening presses of other input keys 103, replaces the previously selected character with a cyclically subsequent character mapped to that multi-function key.

Referring to FIG. 6A, an exemplary flowchart of blocks of code of the key mapping unit of the input management system in the second program codes memory store 148 in the “multi-tap correction cycle” mode is shown generally at 180.

The process 180 begins at 182, where an input key event is received from the operating system in the first program codes memory store 146. In the first embodiment, the operating system in the first program codes memory store 146 generates an input key event in response to an input key signal received in the I/O 154 and causes the process 180 to begin at 182. As explained above, an input key event can represent a press or release of an input key 103.

The process 180 continues at block 184, which directs the microprocessor 142 to determine whether the input key event received at 182 represents a “key pressed” event from a multi-function key 104.

If at block 184 the input key event received at 182 represents a “key pressed” event of a multi-function key 104, the process 180 continues at block 186. The program codes in block 186 direct the microprocessor 142 to determine whether (a) the input key event received at 182 is from the same input key 103 as the input key 103 from the most recent “key pressed” event, and (b) the input key event received at 182 was received within a period of time T₁ from the most recent “key pressed” input key event. In the first embodiment, the period of time T₁ is 1.0 seconds. However, in other embodiments, the period of time T₁ may be any suitable period of time, and it may be configurable by the user.

If at block 186 both conditions (a) and (b) are met, then the user may be considered to be in a correction cycle, and the process 180 continues at block 188, which directs the microprocessor 142 to replace the most-recently added character in the data buffer 164 with a character that is cyclically subsequent to the most-recently added character in the dynamically ordered sequence of available following characters associated with the actuated key in the sixth RAM store 168, and that may be referred to as a “revised following character hypothesis” or more generally as a “following character hypothesis”. The expression “cyclically subsequent” means that after the last character in the dynamically ordered sequence of available following characters associated with the actuated key in the sixth RAM store 168 has been inserted, a subsequent actuation of the actuated key in a correction cycle inserts again the first character in the dynamically ordered sequence of available following characters associated with the actuated key in the sixth RAM store 168.

The process 180 then continues at block 189, which directs the microprocessor 142 to update the dictionary search path data structures in the fourth RAM store 166 to reflect the removal at block 188 of the previously added character in the data buffer 164. To accomplish this, the program codes in block 189 direct the microprocessor 142 to adjust each dictionary search path data structure in the fourth RAM store 166 to point to the immediately previous node in the dictionary 172.

The process 180 then continues at block 193, which directs the microprocessor 142 to update the dictionary search path data structures in the fourth RAM store 166 to reflect insertion of the character newly added at block 188, as described in detail above by example with reference to FIG. 5. The process 180 then ends at 194.

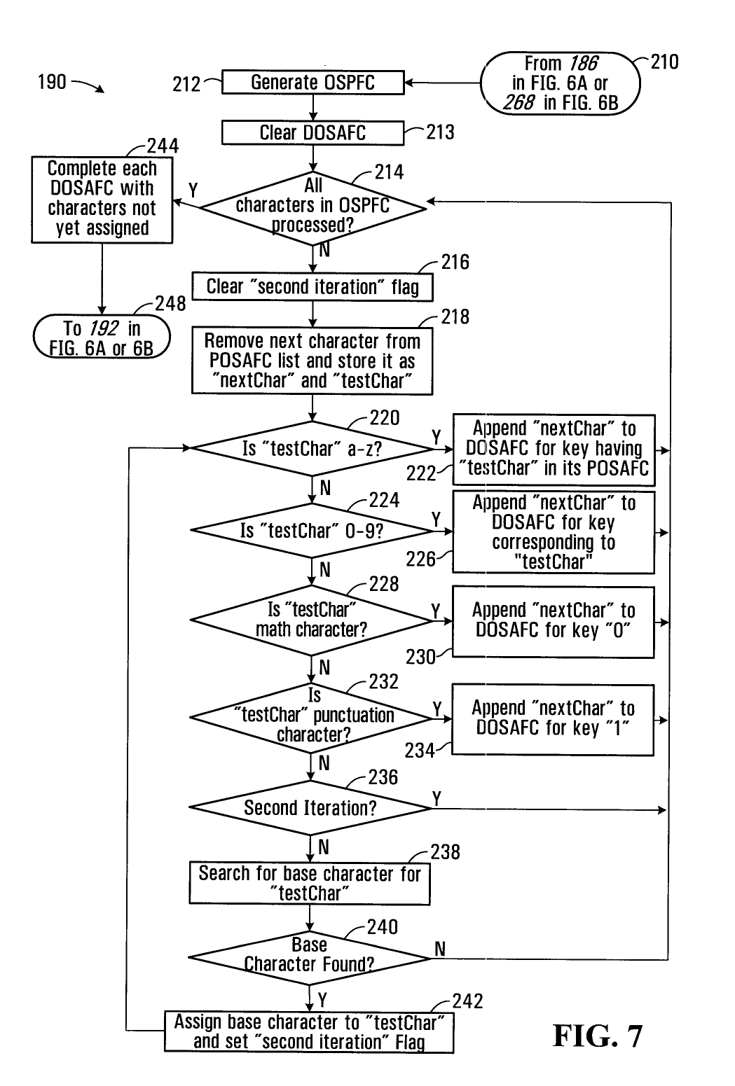

But if at block 186 one or both of conditions (a) and (b) are not met, then the user is considered not to be in a correction cycle. Therefore, the process 180 continues at block 190, which directs the microprocessor 142 to generate dynamically ordered sequences of available following characters associated with the multi-function keys 104, and to store same in the sixth RAM store 168. Exemplary program codes at block 190 are discussed in detail below with reference to FIG. 7.

The process 180 then continues at block 192, which directs the microprocessor 142 to insert in the data buffer 164, at the location specified by the data buffer index in third RAM store 165, a character that is first in the dynamically ordered sequence of available following characters in the sixth RAM store 168 associated with the actuated key, and that may be referred to as a “first following character hypothesis” or more generally as a “following character hypothesis”.

The process 180 then continues at block 193, which directs the microprocessor 142 to update the dictionary search path data structures in the fourth RAM store 166 to reflect insertion of the character newly added at block 192, as described in detail above by example with reference to FIG. 5. The process 180 then ends at 194.

If at block 184, the input key event received at 182 does not represent a “key pressed” event of a multi-function key 104, then the process 180 continues at block 195, which directs the microprocessor 142 to determine whether the user is in a “words only” mode. If at block 195 the user is not in a “words only” mode, then the process 180 then ends at 194.

But if at block 195 the user is in a “words only” mode, then the process 180 continues at block 196, which directs the microprocessor 142 to determine whether the input key event received at 182 represents a “key pressed” event of the space character key. In the first embodiment, the space character key is the “#” input key 103, but in other embodiments, any other input key 103 may be used to insert a space character. If at block 196 the input key event received at 182 does not represent a “key pressed” event of the space character key, then the process 180 ends at 194.

But if at block 196 the input key event received at 182 does represent a “key pressed” event of the space character key, then the process 180 continues at block 197, which directs the microprocessor 142 to clear all dictionary search path data structures in the fourth RAM store 166 to reflect the end of a word, and therefore the end of the current prefix. The process 180 then ends at 194.

In other embodiments, the key mapping unit of the input management system in the second program codes memory store 148 may cause the microprocessor 142 to generate one or more dynamically ordered sequences of available following characters to be stored in the sixth RAM store 168 after the period of time T₁ has elapsed since the last input key event, advantageously providing a faster response time on actuation of a multi-function key 104, and advantageously permitting the computing device 100 to display the dynamically ordered sequences of available following characters to be stored in the sixth RAM store 168 for the user to see before the user actuates an input key 103. This approach is particularly useful in embodiments that include a virtual keyboard-type device comprising virtual representations of the input keys 103, or in embodiments where the input keys 103 form part of a graphically delimited portion of a touch-sensitive screen.

Key Mapping Unit in “Hold-to-Scan Correction Cycle” Mode

As mentioned above, the first embodiment is capable of being configured in the “multi-tap correction cycle” mode, the “hold-to-scan correction cycle” mode, or the “slow-tap correction cycle” mode.

Generally speaking, in the “hold-to-scan correction cycle” mode, the first press of a multi-function key 104 selects a first character from the plurality of characters mapped to that multi-function key 104, and holding the same multi-function key 104 for a period of time, whether or not the multi-function key 104 has been released after a previous press, replaces the previously selected character with a cyclically subsequent character mapped to that multi-function key 104, as long as there have been no intervening presses of other input keys 103.

Referring to FIG. 6B, an exemplary flowchart of blocks of code of the key mapping unit of the input management system in the second program codes memory store 148 in the “hold-to-scan correction cycle” mode is shown generally at 260.

In the “hold-to-scan correction cycle” mode, pressing a multi-function key 104 after a previous press of the same multi-function key, with no intervening presses of input keys 103, can have two effects. If the duration of the subsequent press is less than a relevant period of time, then the subsequent press is not part of a correction cycle, but rather it causes a character to be added to the data buffer 164. But if the duration of the subsequent press is equal to or longer than the relevant period of time, then the subsequent press is part of a correction cycle, and it causes a character to be replaced to the data buffer 164. Therefore, in the first embodiment, a “key pressed” event from a multi-function key 104 that follows a previous press of the same multi-function key, with no intervening presses of input keys 103, does not have any effect on the data buffer 164 or on the displayed text 120. Instead, in the first embodiment, the “key released” event from the multi-function key 104 will cause a character to be added to the data buffer 164 if the multi-function key was held for a period of time less than the relevant period of time, and the “key released” event from the multi-function key 104 will not cause a character to be added to the data buffer 164 if the multi-function key was held for a period of time as least as long as the relevant period of time.

To achieve this result, when in the “hold-to-scan correction cycle” mode, blocks of code in the process 260 set or clear a Boolean “successive key pressed” flag. As explained in detail below, a “key released” key event from a multi-function key 104 will cause a character to be added to the data buffer 164 if the Boolean “successive key pressed” flag has been set, and a “key released” event from a multi-function key 104 will not cause a character to be added to the data buffer 164 if the Boolean “successive key pressed” flag has been cleared.

As in the process 180, the process 260 can begin at 182, where an input key event is received from the operating system in the first program codes memory store 146. As explained above, the operating system in the first program codes memory store 146 generates an input key event in response to an input key signal received in the I/O 154. An input key event can represent a press or release of an input key 103, and causes the process 180 to begin at 182.

However, the process 260 can also begin at 278, where a correction cycle timing event (also referred to herein as a “CC timing event”) is received from a correction cycle timer (also referred to herein as a “CC timer”) in the operating system in the first program codes memory store 146. The function of the CC timer and of CC timing events is explained in detail below.

In the first embodiment, both input key events and CC timing events are generated by the operating system in the first program codes memory store 146, and are executed in the process 260. In the first embodiment, the process 260 may respond to input key events and CC timing events in any sequence, but will respond to one such event at a time.

When a key event is received at 182, the process 260 continues at block 261, which directs the microprocessor 142 to determine whether the input key event received at 182 represents actuation of a multi-function key 104.

If at block 261 the input key event received at 182 is from a multi-function key 104, then the process 260 continues at block 262, which directs the microprocessor 142 to determine whether the input key event received at 182 represents a “key pressed” event.

If at block 262 the input key event received at 182 represents a “key pressed” event, then the process 260 continues at block 264, which directs the microprocessor 142 to cause the CC timer to generate a CC timing event after a period of time T₂, unless the CC timer has been cancelled in one or more of blocks 272, 276, or 279, as discussed below. Generally speaking, as will be explained in detail below, the CC timer generates a CC timing event when the user has held a multi-function key 104 for a period of time T₂, and the microprocessor 142 responds to the CC timing event by causing a correction cycle. In the first embodiment, the period of time T₂ is 1.0 seconds. However, in other embodiments, the period of time T₂ may be any suitable period of time, and it may be configurable by the user.

The process 260 continues at block 266, which directs the microprocessor 142 to determine whether the input key event received at 182 is from the same input key 103 as the input key 103 from the most recent “key pressed” event.

If at block 266 the input key event received at 182 is not from the same input key 103 as the input key from the most recent “key pressed” event, then the user is not in a correction cycle, and the process 260 continues at block 268, which directs the microprocessor 142 to clear the Boolean “successive key press” flag.

The process 260 then continues at block 190, which directs the microprocessor 142 to generate dynamically ordered sequences of available following characters associated with the multi-function keys 104, and to store same in the sixth RAM store 168.

Exemplary program codes at block 190 are discussed in detail below with reference to FIG. 7.

The process 260 then continues at block 192, which directs the microprocessor 142 to insert in the data buffer 164, at the location specified by the data buffer index in third RAM store 165, a character that is first in the dynamically ordered sequence of available following characters in the sixth RAM store 168 associated with the actuated key, and that may be referred to as a “first following character hypothesis” or more generally as a “following character hypothesis”, as described above by example with reference to FIG. 6A.

The process 260 then continues at block 193, which directs the microprocessor 142 to update the dictionary search path data structures in the fourth RAM store 166 to reflect insertion of the character newly added at block 192, as described in detail above by example with reference to FIGS. 5 and 6A. The process 260 then ends at 194.

But if at block 266 the input key event received at 182 is from the same input key 103 as the input key 103 from the most recent “key pressed” event, then the process 260 continues at block 270, which directs the microprocessor 142 to set the Boolean “successive key press” flag, and then the process 260 ends at 194.

If at block 262 the input key event received at 182 does not represent a “key pressed” event, then the input key event received at 182 represents a “key released” event. Because the user has released the multi-function key 104, the correction cycles that result from CC timing events are no longer desired. Therefore, the process 260 continues at block 272, which directs the microprocessor 142 to cancel the CC timer.

The process 260 continues at block 274, which directs the microprocessor 142 to determine whether the Boolean “successive key press” flag has been set. If at block 274 the Boolean “successive key press” flag has not been set, then the process 260 ends at 194. But if at block 274 the Boolean “successive key press” flag has been set, then the user has entered a character and is not in a correction cycle. Therefore, the process 260 continues at blocks 268, 190, 192, and 193, as explained above, and the process 260 then ends at 194.

If at block 261 the input key event received at 182 is not from a multi-function key 104, then the process 260 continues at block 276, which directs the microprocessor 142 to cancel the CC timer and clear the Boolean “successive key press” flag.

The process 260 continues at block 195, which directs the microprocessor 142 to determine whether the user is in a “words only” mode. If at block 195 the user is not in a “words only” mode, then the process 260 then ends at 194.

But if at block 195 the user is in a “words only” mode, then the process 260 continues at block 196, which directs the microprocessor 142 to determine whether the input key event received at 182 represents a “key pressed” event of the space character key. In the first embodiment, the space character key is the “#” input key 103, but in other embodiments, any other input key 103 may be used to insert a space character. If at block 196 the input key event received at 182 does not represent a “key pressed” event of the space character key, then the process 260 ends at 194.

But if at block 196 the input key event received at 182 does represent a “key pressed” event of the space character key, then the process 260 continues at block 197, which directs the microprocessor 142 to clear all dictionary search path data structures in the fourth RAM store 166 to reflect the end of a word, and therefore the end of the current prefix. The process 260 then ends at 194.

When a CC timing is received at 278, the process 260 continues at block 279, which directs the microprocessor 142 to cancel the CC timer. The process 260 then continues at block 280, which directs the microprocessor 142 to re-start the CC timer to produce another CC timing event after a period of time T₃ passes. In the first embodiment, the period of time T₃ is 1.3 seconds. Because the period of time T₃ is greater than the period of time T₂ in the first embodiment, the first correction cycle for a given multi-function key 104 will happen faster than subsequent correction cycles while the user continues to hold the same multi-function key 104. However, in other embodiments, the period of time T₃ may be any suitable period of time (including the period of time T₂), and it may be configurable by the user.

The process 260 then continues at block 282, which directs the microprocessor 142 to clear the Boolean “successive key press” flag. Then, the process 260 continues at block 188, which directs the microprocessor 142 to replace the previously added character in the data buffer 164 with a character that is cyclically subsequent to the previously inserted character in the dynamically ordered sequence of available following characters associated with the actuated key in the sixth RAM store 168, and that may be referred to as a “revised following character hypothesis” or more generally as a “following character hypothesis”, as described above by example with reference to FIG. 6A.

The process 260 then continues at block 189, which directs the microprocessor 142 to update the dictionary search path data structures in the fourth RAM store 166 to reflect the removal at block 188 of the previously added character in the data buffer 164, as described above by example with reference to FIG. 6A.

The process 260 then continues at block 193, which directs the microprocessor 142 to update the dictionary search path data structures in the fourth RAM store 166 to reflect insertion of the character newly added at block 188, as described in detail above by example with reference to FIG. 5. The process 260 then ends at 194.

Key Mapping Unit in “Slow-tap Correction Cycle” Mode

As mentioned above, the first embodiment is capable of being configured in the “multi-tap correction cycle” mode, the “hold-to-scan correction cycle” mode, or the “slow-tap correction cycle” mode.

In the “slow-tap correction cycle” mode, a tap having a duration greater than or equal to the period of time T₂ is treated as a correction cycle, whereas a tap having a duration less than the period of time T₂ inserts a new character. Referring to FIG. 6B, the “slow-tap correction cycle” mode may be implemented by varying the process 260 to omit the block 280 that re-starts the CC timer after a CC timing event.

Key Mapping Unit in Other Embodiments

In other embodiments, a tentative character icon (not shown) may be displayed on the display 102 to display distinctly for the user a tentatively selected character. Once the tentatively selected character becomes “confirmed”, either because the user has actuated another input key 103 or, in the “multi-tap correction cycle mode” because the period of time T₁ has passed, the tentative character icon would be removed and the “confirmed” character would then be displayed in the displayed text 120.

In still other embodiments, particularly in embodiments where the processing speed of the microprocessor 142 is a limiting factor in the overall performance of the computing device 100, the program codes at block 190 may generate a dynamically ordered sequence of available following characters to be stored in the sixth RAM store 168 only for the actuated one of the multi-function keys 104, or for any subset of the multi-function keys 104.

In still other embodiments, the number of multi-function keys 104 available for dynamically ordered sequences of available following characters to be stored in the sixth RAM store 168 may be reduced as the length of the prefixes represented by the dictionary search path data structures in the fourth RAM store 166 increases. For example, once a prefix represented by a dictionary search path data structure in the fourth RAM store 166 reaches at least two characters, dynamically ordered sequences of available following characters to be stored in the sixth RAM store 168 may be generated only for three multi-function keys 104.

In still other embodiments, the key mapping unit of the input management system in the second program codes memory store 148 may cause the microprocessor 142 to generate one or more dynamically ordered sequences of available following characters to be stored in the sixth RAM store 168 after the user has actuated an input key 103 that varies the relevant prefixes used by the prediction engine (such as, by way of example, the left arrow key 110, the right arrow key 112, or the backspace key 114), advantageously providing for a faster response time on actuation of a multi-function key 104, and advantageously permitting the computing device 100 to display the dynamically ordered sequences of available following characters to be stored in the sixth RAM store 168 for the user to see before the user actuates an input key 103. This approach is particularly useful in embodiments that include a virtual keyboard-type device comprising virtual representations of the input keys 103, or in embodiments where the input keys 103 form part of a graphically delimited portion of a touch-sensitive screen.

Generating Dynamically Ordered Sequences of Available Following Characters

The key mapping unit generates dynamically ordered sequences of available following characters associated with the multi-function keys 104 to be stored in the sixth RAM store 168. As explained above, the ordered character sequence associated with the multi-function keys 104 is customized to the particular prefix or prefixes represented by the dictionary search path data structures in the fourth RAM store 166, and advantageously the user may enter data with potentially fewer correction cycles.

Referring to FIG. 7, an exemplary flowchart of blocks of code for directing the microprocessor 142 to generate dynamically ordered sequences of available following characters associated with the multi-function keys 104 and to store same in the sixth RAM store 168 is shown generally at 190.

As explained above, the process 190 is part of the process 180 shown in FIG. 6A and it is part of the process 260 shown in FIG. 6B. Therefore, the process 190 begins at 210, continuing after either block 186 in the process 180 shown in FIG. 6A or after block 268 in the process 260 shown in FIG. 6B. If the process 190 began after block 186 in the process 180 shown in FIG. 6A, then when the process 190 terminates at 248, it returns to block 192 in the process 180 shown in FIG. 6A. However, if the process 190 began after block 268 in the process 260 shown in FIG. 6B, then when the process 190 terminates at 248, it returns to block 192 in the process 260 shown in FIG. 6B.

The process 190 continues at block 212, which directs the microprocessor 142 to generate an ordered sequence of predicted following characters, and to store same in the first RAM store 162.

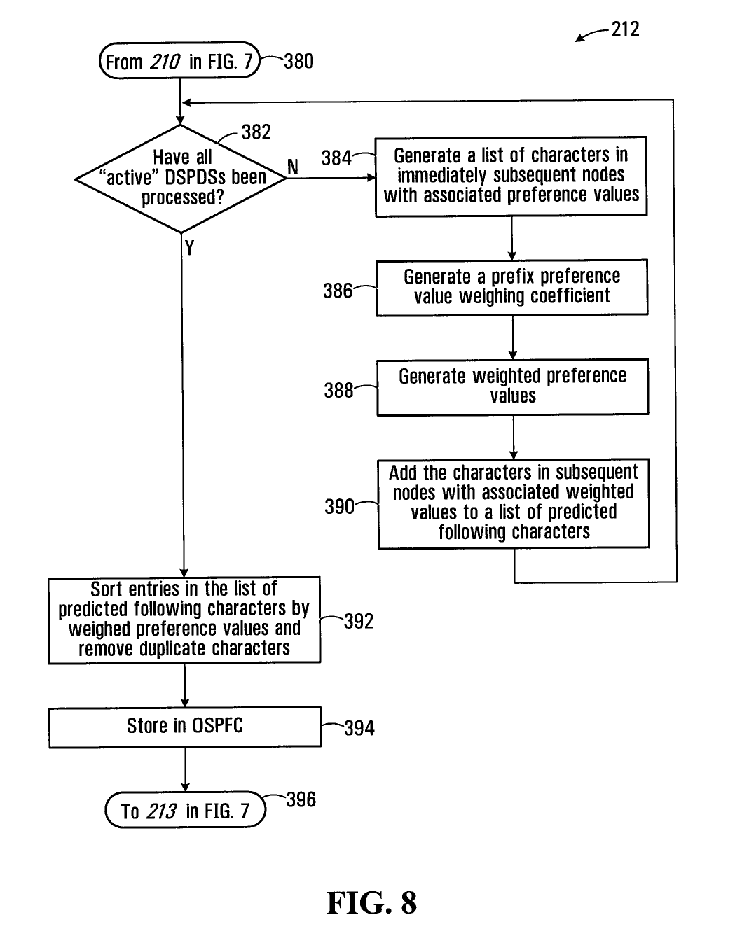

Referring to FIG. 8, an exemplary flowchart of blocks of code for directing the microprocessor 142 to perform the function of block 212 is shown. The process 212 begins at 380, continuing after 210 in FIG. 7.

The process 212 iterates through each “active” dictionary search path data structure in the fourth RAM store 166. Therefore, the process 212 continues at 382, which directs the microprocessor 142 to determine whether all of the “active” dictionary search path data structures in the fourth RAM store 166 have been considered in the process 212.

If at block 382 not all of the “active” dictionary search path data structures in the fourth RAM store 166 have been considered in the process 212, then the process 212 continues at block 384.

Before proceeding at block 384, the microprocessor 142 identifies an “active” dictionary search path data structure in the fourth RAM store 166 that has yet to be considered in the process 212, which is referred to in the description below of the blocks 384, 386, 388, and 390 as “the currently processed dictionary search path data structure in the fourth RAM store 166.”

The program codes in block 384 direct the microprocessor 142 to generate a list of characters and associated preference values represented by nodes that are immediately subsequent to the node pointed to by the currently processed dictionary search path data structure in the fourth RAM store 166.

In the example of FIG. 4, the first iteration of block 384 (following the first dictionary search path data structure 166A) would generate a list of two characters and associated preference values (“p” p.v. 50; “x” p.v. 120), and the second iteration of block 384 (following the second dictionary search path data structure 166B) would generate a list of three characters and associated preference values (“p” p.v. 110; “r” p.v. 140; “x” p.v. 80).

The process 212 continues at block 386, which directs the microprocessor 142 to generate a prefix preference value weighting coefficient for the currently processed dictionary search path data structure in the fourth RAM store 166. In the first embodiment, the preference values from a prefix with more words or partial words are weighted more heavily than the preference values from a prefix with fewer words or partial words, according to the prefix preference value weighting coefficients, to reflect an assumption that a prefix with more words or partial words has a greater predictive power. In the first embodiment, the prefix preference value weighting coefficient is a whole number representing the number of words or partial words in the prefix represented by the currently processed dictionary search path data structure in the fourth RAM store 166. However, in other embodiments, prefix preference value weighting coefficients may be calculated in other ways, or may not be used at all.

In the “words only” mode in the first embodiment, the prefix preference value weighting coefficient will always be 1. However, in the example of FIG. 4, the first iteration of block 386 (following the first dictionary search path data structure 166A) would generate a prefix preference value weighting coefficient of 2 (because the first dictionary search path data structure 166A represents a prefix “the ta” having two words or partial words), and the second iteration of block 386 (following the second dictionary search path data structure 166B) would generate a prefix preference value weighting coefficient of 1 (because the second dictionary search path data structure 166B represents a prefix “ta” having only one word or partial word).

The process 212 continues at block 388, which directs the microprocessor to generate a list of characters and associated weighted preference values by multiplying the preference values identified above by the prefix preference value weighting coefficient identified above. In alternative embodiments that do not use prefix preference value weighting coefficients, block 388 may be omitted.

In the example of FIG. 4, the first iteration of block 388 (following the first dictionary search path data structure 166A) would generate a list of two characters where associated weighted preference values are double the original associated preference values (“p” p.v. 100; “x” p.v. 240) because the prefix preference value weighting coefficient was 2, and the second iteration of block 388 (following the second dictionary search path data structure 166B) would generate a list of three characters where the associated weighted preference values are the same as the original associated preference values (“p” p.v. 110; “r” p.v. 140; “x” p.v. 80) because the prefix preference value weighting coefficient was 1.

The process 212 continues at block 390, which directs the microprocessor 142 to add the list of characters and associated weighted preference values generated in block 388 to a list of predicted following characters. The list of predicted following characters is empty at the beginning of the process 212, and includes the characters and associated weighted preference values that are generated in all of the iterations of the blocks 384, 386, and 388 in the process 212. The list of predicted following characters is used later in the process 212 at block 392, as described in detail below.

In the example of FIG. 4, the first iteration of block 390 (following the first dictionary search path data structure 166A) would cause two characters and associated weighted preference values (“p” p.v. 100; “x” p.v. 240) to be in the list of predicted following characters, and the second iteration of block 390 (following the second dictionary search path data structure 166B) would cause three characters and associated weighted preference values (“p” p.v. 110; “r” p.v. 140; “x” p.v. 80) to be in the list of predicted following characters. Thus, in the example of FIG. 4, the list of predicted following characters would include (“p” p.v. 100; “x” p.v. 240; “p” p.v. 110; “r” p.v. 140; “x” p.v. 80) after both iterations of block 390.

The process 212 then returns to block 382 to determine whether all of the “active” dictionary search path data structures in the fourth RAM store 166 have been considered in the process 212.

If at block 382 all of the “active” dictionary search path data structures in the fourth RAM store 166 have been considered in the process 212, then the process 212 continues at block 392, which directs the microprocessor 142 to generate an ordered sequence of predicted following characters by sorting the elements of the list of predicted following characters in decreasing order of preference value and removing duplicate characters. In the example of FIG. 4, the ordered sequence of predicted following characters resulting from block 392 would be (“x”, “r”, “p”). The process 212 continues at block 394, which directs the microprocessor 142 to store the ordered sequence of predicted following characters generated at block 392 in the first RAM store 162. The process 212 ends at 396, which returns to block 213 in FIG. 7.

In other embodiments, other methods of generating an ordered sequence of predicted following characters would be possible. For example, when a character appears more than once in the list of predicted following characters generated in iterations of block 390, associated weighted preference values for that character may be added together at block 392 before the list of predicted following characters is sorted.

In still other embodiments, generating an ordered sequence of predicted following characters would not be necessary. It is possible to use any method of generating relative preferences for characters in a set of predicted following characters.

Referring back to FIG. 7, the process 190 continues at block 213, which directs the microprocessor 142 to clear the dynamically ordered sequences of available following characters in the sixth RAM store 168. The process 190 then continues at block 214.

The process 190 iterates through each of the characters in the ordered sequence of predicted following characters in the first RAM store 162 that were generated in block 212 as described in detail above. Thus, block 214 directs the microprocessor 142 to determine whether there are characters in the ordered sequence of predicted following characters in the first RAM store 162 that have yet to be considered in the process 190.

If at block 214 there are characters in the ordered sequence of predicted following characters in the first RAM store 162 that have yet to be considered in the process 190, then the process 190 continues at block 216, which directs the microprocessor 142 to clear a Boolean ‘second iteration’ flag. Clearing the Boolean ‘second iteration’ flag signifies that the process 190 is in a first iteration for the current character. As explained in detail below, the process 190 may involve two iterations for a given character.

The process 190 continues at block 218, which directs the microprocessor 142 to identify a next character from the ordered sequence of predicted following characters in the first RAM store 162, and store same in two variables: ‘nextChar’ and ‘testChar’. The character that is identified and stored in block 218 is the most likely character in the ordered sequence of predicted following characters in the first RAM store 162 that has not already been identified and stored in a previous execution of block 218.

The process 190 continues at block 220, which directs the microprocessor 142 to determine whether the character stored in ‘testChar’ is an English-language alphabetical character, that is, from character set (1) as defined above. If the character stored in ‘testChar’ is an English-language alphabetical character, then the process 190 continues at block 222, which directs the microprocessor 142 to append the character stored in ‘nextChar’ to the end of the dynamically ordered sequence of available following characters in the sixth RAM store 168 corresponding to the multi-function key 104 that has ‘testChar’ in its respective preliminary ordered sequence of available following characters in the fifth RAM store 167. The process 190 then returns to block 214 to determine whether there are other characters in the ordered sequence of predicted following characters in the first RAM store 162 that have yet to be considered in the process 190.

If at block 220, the character stored in ‘testChar’ is not an English-language alphabetical character, then the process 190 continues at block 224, which directs the microprocessor 142 to determine whether the character stored in ‘testChar’ is a number character, that is, from character set (2) as defined above. If the character stored in ‘testChar’ is a number character, then the process 190 continues at block 226, which directs the microprocessor 142 to append the character stored in ‘nextChar’ to the end of the dynamically ordered sequence of available following characters in the sixth RAM store 168 corresponding to the multi-function key 104 that corresponds to ‘testChar’. Thus, for example, if ‘testChar’ is “1”, then ‘nextChar’ will be appended to the end of the dynamically ordered sequence of available following characters in the sixth RAM store 168 corresponding to the multi-function key 104 “1”. The process 190 then returns to block 214 to determine whether there are other characters in the ordered sequence of predicted following characters in the first RAM store 162 that have yet to be considered in the process 190.

If at block 224, the character stored in ‘testChar’ is not a number character, then the process 190 continues at block 228, which directs the microprocessor 142 to determine whether the character stored in ‘testChar’ is a mathematical character, that is, from character set (3) as defined above. If the character stored in ‘testChar’ is a mathematical character, then the process 190 continues at block 230, which directs the microprocessor 142 to append the character stored in ‘nextChar’ to the end of the dynamically ordered sequence of available following characters in the sixth RAM store 168 corresponding to the multi-function key 104 labeled “0”. The process 190 then returns to block 214 to determine whether there are other characters in the ordered sequence of predicted following characters in the first RAM store 162 that have yet to be considered in the process 190.

If at block 228, the character stored in ‘testChar’ is not a mathematical character, then the process 190 continues at block 232, which directs the microprocessor 142 to determine whether the character stored in ‘testChar’ is a punctuation character, that is, from character set (4) as defined above. If the character stored in ‘testChar’ is a punctuation character, then the process 190 continues at block 234, which directs the microprocessor 142 to append the character stored in ‘nextChar’ to the end of the dynamically ordered sequence of available following characters in the sixth RAM store 168 corresponding to the multi-function key 104 “1”. The process 190 then returns to block 214 to determine whether there are other characters in the ordered sequence of predicted following characters in the first RAM store 162 that have yet to be considered in the process 190.

If at block 232, the character stored in ‘testChar’ is not a punctuation character, then the process 190 continues at block 236, which directs the microprocessor 142 to determine whether the Boolean ‘second iteration’ flag is set. If the Boolean ‘second iteration’ flag is not set, then the process 190 is still on a first iteration for the presently processed character from the ordered sequence of predicted following characters in the first RAM store 162, and the process 190 then determines whether the presently processed character from the ordered sequence of predicted following characters in the first RAM store 162 is a derived character, that is, from character set (5) described above.

If at block 236 the Boolean ‘second iteration’ flag is not set, then the process 190 continues at block 238, which directs the microprocessor 142 to search for a base character corresponding to the character stored in ‘testChar’. As explained above, in the first embodiment, each derived character is associated with a base character according to a character correspondence table.

The process 190 then continues at block 240, which directs the microprocessor 142 to determine whether a base character was found at block 238. If a base character was found at block 238, the process 190 continues at block 242, which directs the microprocessor 142 to assign the base character to the variable ‘testChar’ and to set the Boolean ‘second iteration’ flag. The process 190 then continues at block 220 to execute a second iteration using the base character identified at block 238 as the ‘testChar’.

However, if at block 240, a base character was not found at block 238, then the presently processed character is not a derived character from character set (5) described above, and the presently processed character is not assigned to a dynamically ordered sequence of available following characters in the sixth RAM store 168. Thus, the process 190 then returns to block 214 to determine whether there are other characters in the ordered sequence of predicted following characters in the first RAM store 162 that have yet to be considered in the process 190.

If at block 236, the Boolean ‘second iteration’ flag is set, then the process 190 has completed a second iteration for the presently processed character from the ordered sequence of predicted following characters in the first RAM store 162 and the presently processed character from the ordered sequence of predicted following characters in the first RAM store 162 is not in any of the character sets (1) to (5) described above. Again, the presently processed character is not assigned to a dynamically ordered sequence of available following characters in the sixth RAM store 168, and the process 190 then returns to block 214 to determine whether there are other characters in the ordered sequence of predicted following characters in the first RAM store 162 that have yet to be considered in the process 190.

In alternative embodiments where there are no derived characters, the second iteration in the process 190 may be omitted.

If at block 214 there are no characters in the ordered sequence of predicted following characters in the first RAM store 162 that have yet to be considered in the process 190, then the process 190 continues at block 244, which directs the microprocessor 142 to complete each dynamically ordered sequence of available following characters in the sixth RAM store 168 by appending to each dynamically ordered sequence of available following characters in the sixth RAM store 168 all of the characters from the respective preliminary ordered sequence of available following characters in the fifth RAM store 167 that have not already been added to the dynamically ordered sequence of available following characters in the sixth RAM store 168, in the order that those characters appear in the respective preliminary ordered sequence of available following characters in the fifth RAM store 167. The process 190 then ends at 248, which returns to block 192 in FIG. 6A or 6B, as explained above.

Therefore, in summary, the exemplary program codes at block 190 direct the microprocessor 142 to generate dynamically ordered sequences of available following characters associated with respective multi-function keys 104 as follows:
(1) For each multi-function key 104, the respective dynamically ordered sequence of available following characters begins with a first set of characters consisting of the characters, if any, that are (a) found in the respective preliminary ordered sequence of available following characters in the fifth RAM store 167, or derived from base characters that are found in the respective preliminary ordered sequence of available following characters in the fifth RAM store 167, and (b) found in the ordered sequence of predicted following characters in the first RAM store 162, in the order that those characters (or, in the case of derived characters, their base characters) appear in the ordered sequence of predicted following characters in the first RAM store 162.
(2) For each multi-function key 104, the respective dynamically ordered sequence of available following characters ends with a second set of characters consisting of the characters, if any, that are (a) found in the respective preliminary ordered sequence of available following characters in the fifth RAM store 167, but (b) not found in the ordered sequence of predicted following characters in the first RAM store 162, in the order that those characters appear in the respective preliminary ordered sequence of available following characters in the fifth RAM store 167.

In an alternative embodiment, step (2) above (corresponding to block 244 in FIG. 7) could be omitted, so that only the characters that appear in the ordered sequence of predicted following characters in the first RAM store 162 appear in the dynamically ordered sequences of available following characters in the sixth RAM store 168. In this alternative embodiment, the user would be limited to entering only entries from the dictionary 172.

Advantageously, if the dictionary 172 includes an entry that includes a derived character (that is, from the character set (5) described above), when the necessary prefix is represented in a dictionary search path data structure in the fourth RAM store 166, the derived character will, in this example, appear in the dynamically ordered sequence of available following characters in the sixth RAM store 168 that includes the associated base character, and the user will be able to insert the derived character by simply actuating the multi-function key 104 associated with the associated base character.

For example, if a prefix represented by a dictionary search path data structure in the fourth RAM store 166 is “ma”, and the word “mañana” is in the dictionary 172, then the character “ñ” would appear in the predicted following characters in the first RAM store 162. In this example, the program codes at block 190 would direct the microprocessor 142 to include the character “ñ” in the dynamically ordered sequence of available following characters in the sixth RAM store 168 that includes the associated base character, which in this example is “n”. Advantageously, after entering the characters “m” and “a”, the user could enter the remainder of the word “mañana” simply by pressing the multi-function key 104 associated with the base-character “n” and causing the required correction cycles, if any, as described in detail above.

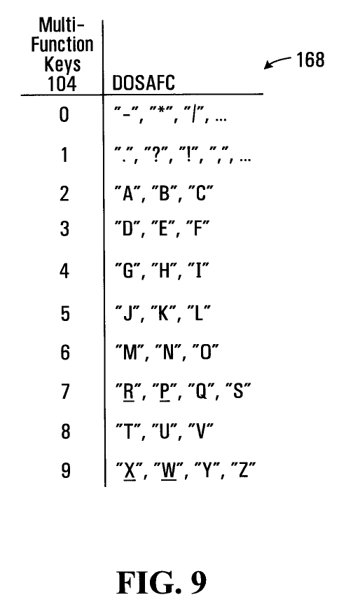

In the example of FIG. 4, the ordered sequence of predicted following characters in the first RAM store 162 was (“x”, “r”, “p”). After the microprocessor 142 has executed the program codes in block 190, the sixth RAM store 168 stores dynamically ordered sequences of available following characters as shown generally at 168 in FIG. 9. In FIG. 9, the characters that appear in a sequence that differs from the preliminary ordered sequences of available following characters in the fifth RAM store 167 are underlined for emphasis.

Thus, in the example of FIGS. 4 and 9, if the user intended to enter the string “the tar”, then the user advantageously needs only to press the multi-function key 104 labeled “7” once, because the multi-function key 104 labeled “7” is associated with the dynamically ordered sequence of available following characters (“R”, “P”, “Q”, “S”). And if the user intended to enter the string “the tax”, then the user advantageously needs only to press the multi-function key 104 labeled “9” once, because the multi-function key 104 labeled “9” in this example is associated with the dynamically ordered sequence of available following characters (“X”, “W”, “Y”, “Z”).

In an alternative embodiment, after the user has pressed a multi-function key 104, the input management system program codes in the second program codes memory store 148 may direct the microprocessor 142 to cause a dynamically ordered key display icon (not shown) to appear on the display 102 to inform the user of the sequence of characters that will be applied using the actuated multi-function key. In the example of FIGS. 4 and 9, if the user pressed the multi-function key 104 labeled “7”, the input management system program codes in the second program codes memory store 148 would direct the microprocessor 142 to cause a dynamically ordered key display icon bearing the dynamically ordered sequence of available following characters (“R”, “P”, “Q”, “S”) to appear on the display 102.

It will be appreciated that the accuracy of the prediction method described above will generally increase significantly with the length of the prefixes represented by dictionary search path data structures in the fourth RAM store 166.

The examples given above have illustrated how the computing device 100 generates dynamically ordered sequences of available following characters in the sixth RAM store 168 where there is at least one character in at least one prefix represented by a dictionary search path data structure in the fourth RAM store 166.

In a first user-configurable option in the first embodiment, the process explained above for generating dynamically ordered sequences of available following characters associated with the multi-function keys 104 in the sixth RAM store 168 is only executed when there is at least one character in at least one prefix represented by the dictionary search path data structures in the fourth RAM store 166. The first user-configurable option in the first embodiment would advantageously provide the user with increased predictability when entering the first character of a word, phrase, and/or other data because the first character would appear in a standard sequence.

However, in a second user-configurable option in the first embodiment, the process explained above generates dynamically ordered sequences of available following characters in the sixth RAM store 168 as described above even when there are no characters in any prefixes represented by a dictionary search path data structure in the fourth RAM store 166. In the second user-configurable option, the process explained above generates dynamically ordered sequences of available following characters associated with the multi-function keys 104 in the sixth RAM store 168 using on the preference values of the nodes that are immediately subsequent to the root node in the dictionary 172. The second user-configurable option in the first embodiment would advantageously enable the user to enter data with potentially fewer correction cycles because the first character that would appear in a word, phrase, and/or other data would be the most likely first character in a word, phrase, and/or other data.

Manual Character Selection

Referring to FIG. 10, as an alternative to the procedure described above, the user may select a character for entry by causing a multi-function key character selection dialog 128 to appear on the display 102.

In the first embodiment, when the user is in the “multi-tap correction cycle” mode described above, the user causes a multi-function key character selection dialog 128 for a given multi-function key 104 to appear on the display 102 by holding down the multi-function key for a pre-determined period of time, and the multi-function key character selection dialog 128 will remain on the display 102 until the user selects a character on it. In the “hold-to-scan correction cycle” mode and “slow-tap correction cycle” mode of the first embodiment, the multi-function key character selection dialog 128 appears as an element in the correction cycle; it appears after the user has cycled past the last character, and before the user cycles back to the first character in the dynamically ordered sequence of available following characters in the sixth RAM store 168.

As shown in FIG. 10, the multi-function key character selection dialog 128 of the first embodiment includes rows and columns of cells, including a highlighted cell 129, and a top row 130. The characters in the preliminary ordered sequence of available following characters in the fifth RAM store 167 associated with the actuated multi-function key 104 each appear in a cell in the top row 130. The user may use the arrow keys 106, 108, 110, and/or 112 to change which cell is the highlighted cell 129.

In the first embodiment, when the user causes a cell in the top row 130 of the multi-function key character selection dialog 128 that includes a character in the preliminary ordered sequence of available following characters in the fifth RAM store 167 associated with the actuated multi-function key 104 to be the highlighted cell 129, all of the derived characters, as explained above, that are associated with the highlighted character in the top row 130 appear in the cells of the multi-function key character selection dialog 128 below the top row 130. For example, referring to FIG. 10, once the user has used the arrow keys 106, 108, 110, and/or 112 to highlight the letter “N” in the top row 130, the derived characters associated with the base character “N” appear in cells in the multi-function key character selection dialog 128 below the top row 130.

However, in the first embodiment, as explained above, if the searchable list 124 is minimized or is displaying no predicted completion candidates, and if the multi-function key character selection dialog 128 is not on the display 102, then the arrow keys 106, 108, 110, and 112 are used for navigation within the active text application in the third program codes memory store 150.

In the first embodiment, the user may use the enter key 116 to select the highlighted character in the multi-function key character selection dialog 128. When the user selects the highlighted character in the multi-function key character selection dialog 128, the microprocessor 142 causes the selected character to replace the most recently added character in the data buffer 164 (because in this example the user will have entered a character by actuating the multi-function key 104 that caused the multi-function key character selection dialog 128 to appear), and the microprocessor 142 updates the dictionary search path data structures in the fourth RAM store 166 to reflect replacing the most recently added character with the selected character, as explained above with reference to blocks 189 and 193 in the examples of FIGS. 5, 6A, and 6B.

Advantageously, the multi-function key character selection dialog 128 of the first embodiment permits the user to insert characters that would not otherwise be associated with a multi-function key 104.

Predicted Completion Candidates

In the first embodiment, the input management system program codes in the second program codes memory store 148 direct the microprocessor 142 to cause a searchable list 124 to appear on the display 102, as shown in FIG. 1 when there is at least one character in at least one prefix represented by a dictionary search path data structure in the fourth RAM store 166.

Examples of searchable lists, which are also referred to “search lists,” are illustrated in International Publication No. WO 02/33527 A2. For example, as illustrated in International Publication No. WO 02/33527 A2, the searchable list 124 may include a suitable number of completion candidates. In the first embodiment, elements in the searchable list 124 are shown in alphabetical order, although other orders may be used. In the first embodiment, the user may minimize the searchable list 124 by pressing the left arrow key 110 twice in succession, and restore the searchable list 124 by holding down the “#” input key 103 for a pre-determined period of time. However, in other embodiments, other methods of controlling the searchable list 124 are possible.

As illustrated in International Publication No. WO 02/33527 A2, a completion candidate in the searchable list 124 may be a “chunk” of a plurality of predicted words that share a common root. For example, if the words “the”, “then”, “there”, “therefore”, and “theological” are in the dictionary 172, then after the user enters the character “t”, the completion candidate “the . . . ” may appear in the searchable list 124 as a representation of “the”, “then”, “there”, “therefore”, and “theological”.

In the first embodiment, the completion candidates in the searchable list 124 are generated using only the shortest prefix among the prefixes represented by the dictionary search path data structures in the fourth RAM store 166. However, in other embodiments, the completion candidates in the searchable list 124 may be generated using all of the prefixes represented by dictionary search path data structures in the fourth RAM store 166, in a manner analogous to the process 212 described above with reference to FIG. 8.

In the first embodiment, the searchable list 124 includes an anchor icon 126, shown in

FIG. 1, identifying the most likely completion candidate in the searchable list. Some of the advantages to using the anchor icon 126 are as follows:
1. The anchor icon 126 indicates which of the predicted completion candidates is the most likely.
2. The anchor icon 126 indicates how much effort is required to reach other candidates when the navigation through the search list 124 would start in the vicinity of the anchor point.
3. The anchor icon 126 offers a quick way of selecting the most likely predicted completion candidate.
4. The anchor icon 126 avoids potential confusion about the effect of the enter key 116. The anchor icon 126 provides a visual indication of the most likely predicted completion candidate without fully highlighting the most likely predicted completion candidate, which could suggest to the user that actuating only a single key, such as the enter key 116, will select the most likely predicted completion candidate.

In other embodiments, a different indication of the most likely completion candidate in the searchable list 124 may be used. For example, the most likely completion candidate in the searchable list 124 may be displayed in bold or italic font, it may be underlined, or it may be displayed in a different colour, or any combination of these or other indications may be used. Alternatively, an indication of the most likely completion candidate may be omitted.

In the first embodiment, when the searchable list 124 is displayed on the display 102, the user may cause a predicted completion candidate in the searchable list 124 to be highlighted. In the first embodiment, a highlighted predicted completion candidate (not shown) in the searchable list 124 is indicated to the user with a differently coloured background. In other embodiments, other indications of a highlighted predicted completion candidate in the searchable list 124 may be used.

In the first embodiment, if no predicted completion candidate in the searchable list 124 is highlighted, and if the user presses the right arrow key 112, the most likely predicted completion candidate marked by the anchor icon 126 is highlighted. If no predicted completion candidate in the searchable list 124 is highlighted, and if the user presses the up arrow key 106, the prediction candidate immediately above the most likely predicted completion candidate marked by the anchor icon 126 is highlighted. If no predicted completion candidate in the searchable list 124 is highlighted, and if the user presses the down arrow key 108, the prediction candidate immediately below the most likely predicted completion candidate marked by the anchor icon 126 is highlighted.

In the first embodiment, once a predicted completion candidate in the searchable list 124 is highlighted, the user can change the highlighted predicted completion candidate by using the up arrow key 106 or the down arrow key 108.

However, in the first embodiment, as explained above, if the searchable list 124 is minimized or is displaying no predicted completion candidates, and if the multi-function key character selection dialog 128 is not on the display 102, then the arrow keys 106, 108, 110, and 112 are used for navigation within the active text application in the third program codes memory store 150.

In the first embodiment, when the searchable list 124 is displayed on the display 102, and even when the user has highlighted a predicted completion candidate in the searchable list 124, the user may still actuate a multi-function key 104 to enter data as described above. When the user actuates a multi-function key 104 to enter data as described above, the procedures described above cause the searchable list 124 to be updated to reflect the inserted character.

In the first embodiment, no predicted completion candidate in the searchable list 124 is highlighted until the user highlights a predicted completion candidate using the arrow keys 106, 108, and/or 112 as explained above. When a predicted completion candidate in the searchable list 124 is highlighted, the user may press the enter key 116 or the right arrow key 112 to select the highlighted predicted completion candidate. The enter key 116 causes the highlighted completion candidate to be selected with a space character after it, and the right arrow key 112 causes the highlighted completion candidate to be selected with no space character after it.

In the first embodiment, when the user selects the highlighted predicted completion in the searchable list 124, the microprocessor 142 causes the characters in the highlighted predicted completion candidate that are not already in the data buffer 164 to be added to the data buffer 164. The microprocessor 142 also updates data buffer index in the third RAM store 165, and the microprocessor 142 updates the dictionary search path data structures in the fourth RAM store 166 to reflect addition of those characters, as explained above by example with reference to FIG. 5. Thus, advantageously, the searchable list 124 in the first embodiment permits the user to insert portions of words, phrases, or other character sequences that would otherwise potentially require additional actuations of the multi-function keys 104.

The distinction between using the enter key 116 and using the right arrow key 112 to select the highlighted predicted completion candidate in the first embodiment is particularly advantageous when the user uses a highlighted predicted completion candidate in the searchable list 124 as a root for a desired word. The ability to use a predicted completion candidate in the searchable list 124 as a root for a desired word is particularly advantageous when the selected predicted completion candidate is a “chunk”, as described above.

For example, in the example from above, where the dictionary 172 includes entries “the”, “then”, “there”, “therefore”, and “theological”, the user can enter the character “t”, and then use the right arrow key 112 to select the completion candidate “the” (“the” with no space character after it) from the searchable list 124. The user can then enter the character “o”, which would cause the completion candidate “theological” to appear in the searchable list 124. The user could then use the enter key 116 to select the completion candidate “theological” with a space after it, allowing the user to proceed to entering a following word. Thus, the first embodiment advantageously permits the user to alternate between data entry using dynamically ordered sequences of predicted following characters in the sixth RAM store 168, and data entry using a search list 124, to achieve an efficient overall data entry method.

In an alternate embodiment where the searchable list 124 appears on a graphically delimited portion of a touch-sensitive screen that can be pressed and released, the user may select a predicted completion candidate from the searchable list 124 by simply touching the desired predicted completion candidate.

In another alternate embodiment, the anchor icon 126 may be absent, and the most likely predicted completion candidate in the searchable list 124 is always highlighted. In this alternate embodiment, therefore, the user may actuate the enter key 116 or the right arrow key 112 to select the highlighted predicted completion candidate in the searchable list 124 and cause the selected predicted completion candidate to complete the data in the data buffer 164, advantageously without necessarily having to use an arrow key 106, 108, or 110 to highlight a predicted completion candidate in the searchable list 124.

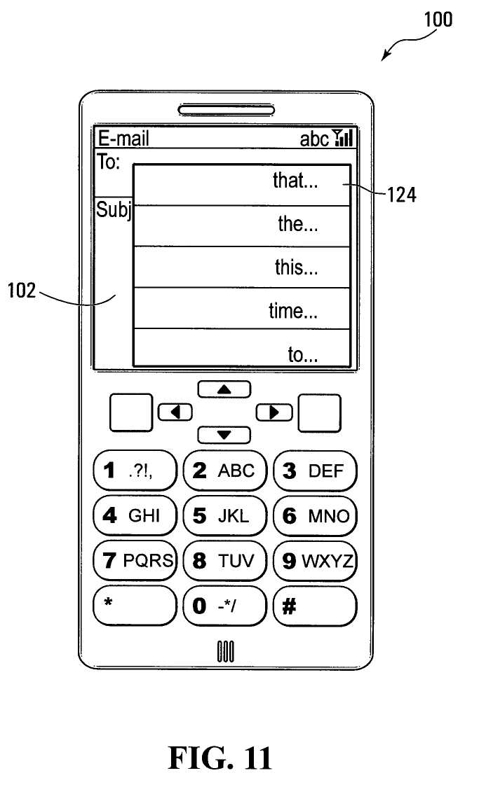

As shown in FIG. 11, in the first embodiment, the user may expand the searchable list 124 to extend over most or all of the display 102 by holding down the input key 103 marked “#” for a pre-determined period of time. When the user releases the input key 103 marked “#”, the searchable list 124 returns to its ordinary size. Expanding the searchable list 124 in this way may assist users with visual impairments, and it permits more words to be displayed in the searchable list 124. Also, in the alternate embodiment described above where the searchable list 124 appears on a graphically delimited portion of a touch-sensitive screen that can be pressed and released, the expanding the searchable list 124 may facilitate touching and selecting the desired predicted completion candidate. Finally, expanding the searchable list 124 may permit including more or longer portions of predicted completion candidates.

Although specific embodiments of the invention have been described and illustrated, such embodiments should not to be construed in a limiting sense. Various modifications of form, arrangement of components, steps, details and order of operations of the embodiments illustrated, as well as other embodiments of the invention, will be apparent to persons skilled in the art upon reference to this description. For instance, various aspects of the invention, including various methods, may be implemented as software, hardware or firmware. It is therefore contemplated that the appended claims will cover such modifications and embodiments as fall within the true scope of the invention. In the specification, including the claims, except where otherwise specifically provided, numeric ranges are inclusive of the numbers defining the range.

1. A method of data entry, the method comprising:
monitoring input from a plurality of input keys of a computing device, wherein said plurality of input keys include a plurality of multi-function keys;
generating a prefix associated with at least one entry in a dictionary in response to input received from at least one of said plurality of input keys, said dictionary comprising:
a plurality of entries each comprising a plurality of characters arranged in an ordered sequence and representing a word, phrase, or character sequence; and
a plurality of preference values each representing a current estimated user preference to select at least one of said plurality of characters of at least one of said plurality of entries to be appended to a tail end of said prefix;
generating a set of predicted following characters, each predicted following character having a representation in said dictionary immediately subsequent to said prefix in said at least one of said plurality of entries, each predicted following character associated with one of said plurality of characters of at least one of said plurality of entries, and associated with one of said preference values;
generating a dynamically ordered sequence of available following characters in respect of an actuated one of said plurality of multi-function keys, comprising at least one of said predicted following characters, wherein when said dynamically ordered sequence of available following characters comprises a plurality of predicted following characters, said plurality of predicted following characters are arranged in an order based on said preference values associated with said plurality of predicted following characters;
generating a following character hypothesis comprising a character in said dynamically ordered sequence of available following characters; and
causing a representation of said dynamically ordered sequence of available following characters to appear on a display associated with the computing device.

2. The method of claim 1 wherein generating a prefix further comprises modifying a reference to a node in said dictionary, said node representing one of said plurality of characters of at least one of said plurality of entries in said dictionary and modifying a dictionary search path data structure.

3. (canceled)

4. The method of claim 1 wherein generating a prefix further comprises generating a plurality of prefixes, each corresponding to at least one entry in said dictionary, and wherein each of said predicted following characters is associated with one of said plurality of prefixes; and further comprising multiplying said preference values associated with said predicted following characters by a respective prefix preference value weighting coefficient.

5. (canceled)

6. The method of claim 1 further comprising multiplying one of said preference values associated with said predicted following characters by a whole number equal to a number of words and partial words in said prefix.

7. The method of claim 1 wherein generating a dynamically ordered sequence of available following characters further comprises associating at least one of said predicted following characters with said actuated one of said multi-function keys of the computing device.

8. (canceled)

9. The method of claim 1 further comprising generating an ordered sequence of available following characters, wherein generating an ordered sequence of available following characters further comprises:
ordering said set of predicted following characters according to said preference values associated with said predicted following characters; and
removing all occurrences of a unique character in said set of predicted following characters except an occurrence of said unique character having a highest associated preference value among all occurrences of said unique character in said set of predicted following characters.

10. The method of claim 1 further comprising generating an ordered sequence of available following characters, wherein generating an ordered sequence of available following characters further comprises:
for each unique character in said set of predicted following characters, combining all occurrences of said unique character in said set of predicted following characters into a single occurrence of said unique character having an associated preference value equal to a sum of all of said preference values associated with all occurrences of said unique character in said set of predicted following characters; and
ordering said set of predicted following characters according to said associated preference values.

11. The method of 1 further comprising generating an ordered sequence of available following characters, wherein when said dynamically ordered sequence of available following characters includes said plurality of predicted following characters, and said plurality of predicted following characters are arranged in an order based on said ordered sequence of available following characters.

12. The method of claim 1 wherein generating a dynamically ordered sequence of available following characters associated with an actuated one of said plurality of multi-function keys further comprises generating a dynamically ordered sequence of available following characters comprising at least one character from a preliminary ordered sequence of available following characters associated with said actuated one of said plurality of multi-function keys.

13. The method of claim 1 wherein generating a following character hypothesis further comprises:
generating a first following character hypothesis in response to a first press of said actuated one of said plurality of multi-function keys;
wherein said first press of said actuated one of said plurality of multi-function keys is associated with at least one of:
occurrence for a minimum period of time greater than a period of time from a most recent previous press of said actuated one of said plurality of multi-function keys; and
a user selection of one of said plurality of input keys other than said actuated one of said plurality of multi-function keys after said most recent previous press of said actuated one of said plurality of multi-function keys and before said first press of said actuated one of said plurality of multi-function keys; and
wherein said first following character hypothesis is a first character in said dynamically ordered sequence of available following characters in respect of said actuated one of said plurality of multi-function keys.

14. The method of claim 10 wherein generating a following character hypothesis further comprises:
generating a revised following character hypothesis in response to a subsequent press of said actuated one of said plurality of multi-function keys;
wherein said first press of said actuated one of said plurality of multi-function keys is not more than said first period of time from said most recent previous press of said actuated one of said plurality of multi-function keys, and wherein one of said plurality of input keys other than said actuated one of said plurality of multi-function keys was not pressed after said most recent previous press of said actuated one of said plurality of multi-function keys and before said first press of said actuated one of said plurality of multi-function keys; and
wherein said revised following character hypothesis is a character in said dynamically ordered sequence of available following characters in respect of said actuated one of said plurality of multi-function keys that is cyclically subsequent to a most recent following character hypothesis.

15. The method of claim 1 wherein generating a following character hypothesis comprises:
generating a first following character hypothesis in response to a first press of said actuated one of said plurality of multi-function keys;
wherein a most recent previous press of one of said plurality of input keys before said first press of said actuated one of said plurality of multi-function keys was not a press of said actuated one of said plurality of multi-function keys; and
wherein said first following character hypothesis is a first character in said dynamically ordered sequence of available following characters in respect of said actuated one of said plurality of multi-function keys.

16. The method of claim 12 wherein generating a following character hypothesis further comprises:
generating a revised following character hypothesis in response to a continuous press of said actuated one of said plurality of multi-function keys throughout a second period of time from a beginning of said continuous press of said actuated one of said plurality of multi-function keys or throughout a third period of time from a most recent generation of a revised following character hypothesis;
wherein said revised following character hypothesis is a character in said dynamically ordered sequence of available following characters in respect of said actuated one of said plurality of multi-function keys that is cyclically subsequent to a most recent following character hypothesis.

17. The method of claim 12 wherein generating a following character hypothesis further comprises:
generating a revised following character hypothesis in response to a continuous press of said actuated one of said plurality of multi-function keys throughout a second period of time from a beginning of said continuous press of said actuated one of said plurality of multi-function keys;
wherein said revised following character hypothesis is a character in said dynamically ordered sequence of available following characters in respect of said actuated one of said plurality of multi-function keys that is cyclically subsequent to a most recent following character hypothesis.

18. The method of claim 1 wherein generating a dynamically ordered sequence of available following characters in respect of said actuated one of said plurality of multi-function keys is in response to actuation of said actuated one of said plurality of multi-function keys.

19. The method of claim 1 wherein generating a dynamically ordered sequence of available following characters in respect of said actuated one of said plurality of multi-function keys is in response to actuation of one of said plurality of input keys.

20. The method of claim 10 wherein generating a dynamically ordered sequence of available following characters in respect of said actuated one of said plurality of multi-function keys is in response to a passage of said minimum period of time from a most recent press of one of said plurality of multi-function keys.

21. (canceled)

22. The method of claim 1 further comprising causing a multi-function key character selection dialog to appear on the display of the computing device, wherein generating a following character hypothesis comprises responding to user selection, via at least one of the plurality of input keys, of a character represented in said multi-function key character selection dialog.

23. (canceled)

24. The method of claim 1 further comprising causing a searchable list comprising at least one predicted completion candidate to appear on the display.

25-26. (canceled)

27. The method claim 19 further comprising causing said searchable list to be resized in response to actuation of at least one of said plurality of input keys.

28. (canceled)

29. The method of claim 1 further comprising causing a representation of said dynamically ordered sequence of available following characters to appear on the display.

30-31. (canceled)

32. A data entry system comprising:
means for monitoring input from a plurality of input keys, wherein said plurality of input keys include a plurality of multi-function keys;
means for generating a prefix associated with at least one entry in a dictionary in response to input received from at least one of said plurality of input keys, said dictionary comprising:
a plurality of entries each comprising a plurality of characters arranged in an ordered sequence and representing a word, phrase, or character sequence; and
a plurality of preference values each representing a current estimated user preference to select at least one of said plurality of characters of at least one of said entries to be appended to a tail end of said prefix;
means for generating a set of predicted following characters, each predicted following character having a representation in said dictionary immediately subsequent to said prefix in said at least one of said plurality of entries, each predicted following character associated with one of said plurality of characters of at least one of said plurality of entries, and associated with one of said preference values;
means for generating a dynamically ordered sequence of available following characters in respect of an actuated one of said plurality of multi-function keys, comprising at least one of said predicted following characters, wherein when said dynamically ordered sequence of available following characters comprises a plurality of predicted following characters, said plurality of predicted following characters are arranged in an order based on said preference values associated with said plurality of predicted following characters; and
means for generating a following character hypothesis comprising a character in said dynamically ordered sequence of available following characters.
